(19) United States
(12) Patent Application Publication
(10) Pub. No.: US 2026/0012633 A1
(43) Pub. Date: Jan. 8, 2026

(54) METHOD FOR PERFORMING AFFINE MOTION COMPENSATION FOR REGRESSION GEOMETRIC PARTITION MODE

(71) Applicant: Alibaba (China) Co., Ltd., Hangzhou (CN)

(72) Inventors: Chen LI, Hangzhou (CN); Ru-ling LIAO, Sunnyvale, CA (US); Jie CHEN, Beijing (CN); Xinwei LI, Beijing (CN); Yan YE, San Diego, CA (US)

(21) Appl. No.: 19/258,109

(22) Filed: Jul. 2, 2025

Related U.S. Application Data
(60) Provisional application No. 63/667,349, filed on Jul. 3, 2024.

(51) Int. Cl. H04N 19/52; H04N 19/107; H04N 19/119; H04N 19/139; H04N 19/184

(52) U.S. Cl. CPC H04N 19/52; H04N 19/107; H04N 19/119; H04N 19/139; H04N 19/184

(57) ABSTRACT

The present disclosure provides a method of encoding a video sequence. The method includes: receiving a video sequence; encoding the video sequence by: constructing a first merge candidate list of pairs of candidates from a regular geometric partition mode (GPM) candidate list for a code unit (CU); constructing one or more additional merge candidate lists of pairs of candidates, wherein each pair of candidates comprises a first motion vector for a first partition and a second motion vector for a second partition, at least one of the pairs of candidates in the one or more additional merge candidate lists comprises an affine motion vector; and encoding the CU using a regression GPM using the first merge candidate list or one of the one or more additional merge candidate lists, wherein the CU comprises a first partition and a second partition.

### CROSS-REFERENCE TO RELATED APPLICATIONS

This disclosure claims the benefits of priority to U.S. Provisional Application No. 63/667,349, filed on Jul. 3, 2024, which is incorporated herein by reference in its entirety.

### TECHNICAL FIELD

The present disclosure generally relates to video processing, and more particularly, to methods, apparatus and a non-transitory computer-readable storage medium for performing affine motion compensation for regression geometric partition mode.

### BACKGROUND

A video is a set of static pictures (or “frames”) capturing the visual information. To reduce the storage memory and the transmission bandwidth, a video can be compressed before storage or transmission and decompressed before display. The compression process is usually referred to as encoding and the decompression process is usually referred to as decoding. There are various video coding formats which use standardized video coding technologies, most commonly based on prediction, transform, quantization, entropy coding and in-loop filtering. The video coding standards, such as the High Efficiency Video Coding (HEVC/H.265) standard, the Versatile Video Coding (VVC/H.266) standard, and AVS standards, specifying the specific video coding formats, are developed by standardization organizations. With more and more advanced video coding technologies being adopted in the video standards, the coding efficiency of the new video coding standards get higher and higher.

### SUMMARY OF THE DISCLOSURE

Embodiments of the present disclosure provide a method for encoding a video sequence. In some embodiments, the method includes: receiving a video sequence; encoding the video sequence by: constructing a first merge candidate list of pairs of candidates from a regular geometric partition mode (GPM) candidate list for a code unit (CU); constructing one or more additional merge candidate lists of pairs of candidates, wherein each pair of candidates comprises a first motion vector for a first partition and a second motion vector for a second partition, at least one of the pairs of candidates in the one or more additional merge candidate lists comprises an affine motion vector; and encoding the CU using a regression GPM using the first merge candidate list or one of the one or more additional merge candidate lists, wherein the CU comprises a first partition and a second partition.

Embodiments of the present disclosure provide a method for decoding a bitstream. In some embodiments, the method includes: receiving a bitstream; and decoding the bitstream to generate a video sequence, the decoding comprising: constructing a first merge candidate list of pairs of candidates from a regular geometric partition mode (GPM) candidate list for a code unit (CU); constructing one or more additional merge candidate lists of pairs of candidates, wherein each pair of candidates comprises a first motion vector for a first partition and a second motion vector for a second partition, at least one of the pairs of candidates in the one or more additional merge candidate lists comprises an affine motion vector; and decoding the CU using a regression GPM using the first merge candidate list or one of the one or more additional merge candidate lists, wherein the CU comprises a first partition and a second partition.

Embodiments of the present disclosure provide a method for signaling a bitstream. In some embodiments, the method includes: receiving a video sequence; encoding the video sequence by: constructing a first merge candidate list of pairs of candidates from a regular geometric partition mode (GPM) candidate list for a code unit (CU); constructing one or more additional merge candidate lists of pairs of candidates, wherein each pair of candidates comprises a first motion vector for a first partition and a second motion vector for a second partition, at least one of the pairs of candidates in the one or more additional merge candidate lists comprises an affine motion vector; and encoding the CU using a regression GPM using the first merge candidate list or one of the one or more additional merge candidate lists, wherein the CU comprises a first partition and a second partition; and signaling a bitstream that is generated based on the encoding.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is a schematic diagram illustrating structures of an exemplary video sequence, according to some embodiments of the present disclosure.

FIG. 2A is a schematic diagram illustrating an exemplary encoding process of a hybrid video coding system, consistent with embodiments of the disclosure.

FIG. 2B is a schematic diagram illustrating another exemplary encoding process of a hybrid video coding system, consistent with embodiments of the disclosure.

FIG. 3A is a schematic diagram illustrating an exemplary decoding process of a hybrid video coding system, consistent with embodiments of the disclosure.

FIG. 3B is a schematic diagram illustrating another exemplary decoding process of a hybrid video coding system, consistent with embodiments of the disclosure.

FIG. 4 is a block diagram of an exemplary apparatus for encoding or decoding a video, according to some embodiments of the present disclosure.

FIG. 5A and FIG. 5B illustrate exemplary control points based affine motion model, according to some embodiments of the present disclosure.

FIG. 6 illustrates an exemplary affine motion vector field (MVF) per subblock, according to some embodiments of the present disclosure.

FIG. 7 illustrates examples of the geometric partition mode (GPM) splits grouped by identical angles, according to some embodiments of the present disclosure.

FIG. 8 illustrates exemplary uni-prediction motion vector (MV) selection for geometric partitioning mode, according to some embodiments of the present disclosure.

FIG. 9 illustrates an exemplary generation of a bending weight using GPM, according to some embodiments of the present disclosure.

FIG. 10 illustrates a ramp function for the weights for GPM blending based on the displacement (d) from a predicted sample position to the GPM partitioning boundary and the blending area size (t), according to some embodiments of the present disclosure.

FIG. 11 illustrates an example for angular weighted prediction (AWP) weight prediction, according to some embodiments of the present disclosure.

FIG. 12 illustrates eight intra prediction angles supported in the AWP mode, according to some embodiments of the present disclosure.

FIG. 13 illustrates seven different weight array settings in the AWP mode, according to some embodiments of the present disclosure.

FIG. 14 illustrates template matching performed on a search area around initial MV, according to some embodiments of the present disclosure.

FIG. 15 illustrates an example flow chart of a method of affine extension for regression GPM, according to some embodiments of the present disclosure.

FIG. 16 illustrates an example flow chart of a method for extending bi-predictive motion vectors to affine GPM, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

The Joint Video Experts Team (JVET) of the ITU-T Video Coding Expert Group (ITU-T VCEG) and the ISO/IEC Moving Picture Expert Group (ISO/IEC MPEG) is currently developing the Versatile Video Coding (VVC/H.266) standard. The VVC standard is aimed at doubling the compression efficiency of its predecessor, the High Efficiency Video Coding (HEVC/H.265) standard. In other words, VVC's goal is to achieve the same subjective quality as HEVC/H.265 using half the bandwidth.

To achieve the same subjective quality as HEVC/H.265 using half the bandwidth, the JVET has been developing technologies beyond HEVC using the joint exploration model (JEM) reference software. As coding technologies were incorporated into the JEM, the JEM achieved substantially higher coding performance than HEVC.

The VVC standard has been developed recently and continues to include more coding technologies that provide better compression performance. VVC is based on the same hybrid video coding system that has been used in modern video compression standards such as HEVC, H.264/AVC, MPEG2, H.263, etc.

A video is a set of static pictures (or “frames”) arranged in a temporal sequence to store visual information. A video capture device (e.g., a camera) can be used to capture and store those pictures in a temporal sequence, and a video playback device (e.g., a television, a computer, a smartphone, a tablet computer, a video player, or any end-user terminal with a function of display) can be used to display such pictures in the temporal sequence. Also, in some applications, a video capturing device can transmit the captured video to the video playback device (e.g., a computer with a monitor) in real-time, such as for surveillance, conferencing, or live broadcasting.

For reducing the storage space and the transmission bandwidth needed by such applications, the video can be compressed before storage and transmission and decompressed before the display. The compression and decompression can be implemented by software executed by a processor (e.g., a processor of a generic computer) or specialized hardware. The module for compression is generally referred to as an “encoder,” and the module for decompression is generally referred to as a “decoder.” The encoder and decoder can be collectively referred to as a “codec.” The encoder and decoder can be implemented as any of a variety of suitable hardware, software, or a combination thereof. For example, the hardware implementation of the encoder and decoder can include circuitry, such as one or more microprocessors, digital signal processors (DSPs), application-specific integrated circuits (ASICs), field-programmable gate arrays (FPGAs), discrete logic, or any combinations thereof. The software implementation of the encoder and decoder can include program codes, computer-executable instructions, firmware, or any suitable computer-implemented algorithm or process fixed in a computer-readable medium. Video compression and decompression can be implemented by various algorithms or standards, such as MPEG-1, MPEG-2, MPEG-4, H.26x series, or the like. In some applications, the codec can decompress the video from a first coding standard and re-compress the decompressed video using a second coding standard, in which case the codec can be referred to as a “transcoder.”

The video encoding process can identify and keep useful information that can be used to reconstruct a picture and disregard unimportant information for the reconstruction. If the disregarded, unimportant information cannot be fully reconstructed, such an encoding process can be referred to as “lossy.” Otherwise, it can be referred to as “lossless.” Most encoding processes are lossy, which is a tradeoff to reduce the needed storage space and the transmission bandwidth.

The useful information of a picture being encoded (referred to as a “current picture”) include changes with respect to a reference picture (e.g., a picture previously encoded and reconstructed). Such changes can include position changes, luminosity changes, or color changes of the pixels, among which the position changes are mostly concerned. Position changes of a group of pixels that represent an object can reflect the motion of the object between the reference picture and the current picture.

A picture coded without referencing another picture (i.e., it is its own reference picture) is referred to as an “I-picture.” A picture is referred to as a “P-picture” if some or all blocks (e.g., blocks that generally refer to portions of the video picture) in the picture are predicted using intra prediction or inter prediction with one reference picture (e.g., uni-prediction). A picture is referred to as a “B-picture” if at least one block in it is predicted with two reference pictures (e.g., bi-prediction).

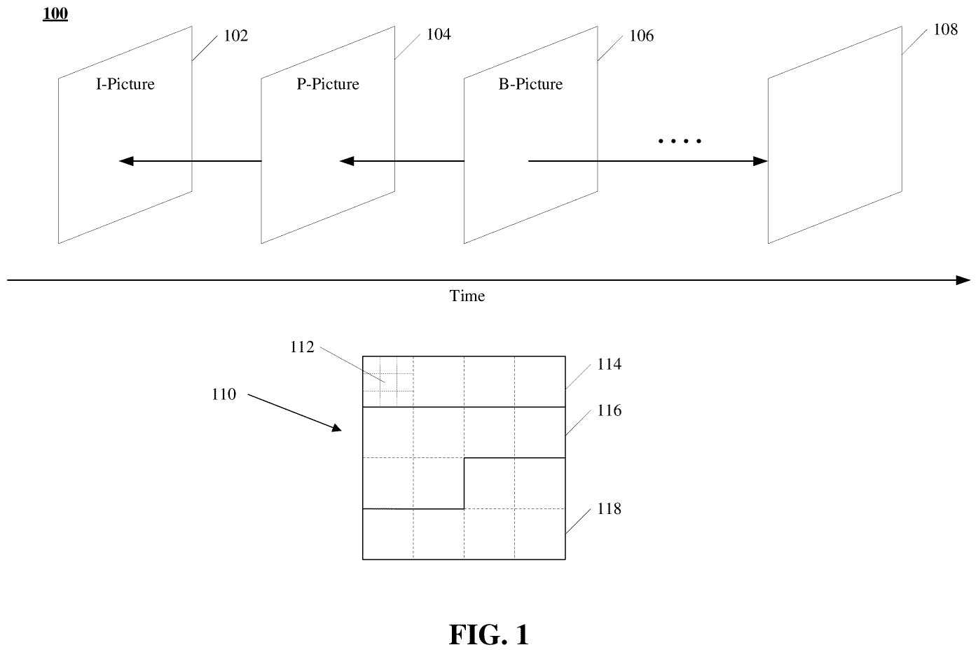

FIG. 1 illustrates structures of an exemplary video sequence 100, according to some embodiments of the present disclosure. Video sequence 100 can be a live video or a video having been captured and archived. Video sequence 100 can be a real-life video, a computer-generated video (e.g., computer game video), or a combination thereof (e.g., a real-life video with augmented-reality effects). Video sequence 100 can be inputted from a video capture device (e.g., a camera), a video archive (e.g., a video file stored in a storage device) containing previously captured video, or a video feed interface (e.g., a video broadcast transceiver) to receive video from a video content provider.

As shown in FIG. 1, video sequence 100 can include a series of pictures arranged temporally along a timeline, including pictures 102, 104, 106, and 108. Pictures 102-106 are continuous, and there are more pictures between pictures 106 and 108. In FIG. 1, picture 102 is an I-picture, the reference picture of which is picture 102 itself. Picture 104 is a P-picture, the reference picture of which is picture 102, as indicated by the arrow. Picture 106 is a B-picture, the reference pictures of which are pictures 104 and 108, as indicated by the arrows. In some embodiments, the reference picture of a picture (e.g., picture 104) can be not immediately preceding or following the picture. For example, the reference picture of picture 104 can be a picture preceding picture 102. It should be noted that the reference pictures of pictures 102-106 are only examples, and the present disclosure does not limit embodiments of the reference pictures as the examples shown in FIG. 1.

Typically, video codecs do not encode or decode an entire picture at one time due to the computing complexity of such tasks. Rather, they can split the picture into basic segments and encode or decode the picture segment by segment. Such basic segments are referred to as basic processing units (“BPUs”) in the present disclosure. For example, structure 110 in FIG. 1 shows an example structure of a picture of video sequence 100 (e.g., any of pictures 102-108). In structure 110, a picture is divided into 4×4 basic processing units, the boundaries of which are shown as dash lines. In some embodiments, the basic processing units can be referred to as “macroblocks” in some video coding standards (e.g., MPEG family, H.261, H.263, or H.264/AVC), or as “coding tree units” (“CTUs”) in some other video coding standards (e.g., H.265/HEVC or H.266/VVC). The basic processing units can have variable sizes in a picture, such as 128×128, 64×64, 32×32, 16×16, 4×8, 16×32, or any arbitrary shape and size of pixels. The sizes and shapes of the basic processing units can be selected for a picture based on the balance of coding efficiency and levels of details to be kept in the basic processing unit.

The basic processing units can be logical units, which can include a group of different types of video data stored in a computer memory (e.g., in a video frame buffer). For example, a basic processing unit of a color picture can include a luma component (Y) representing achromatic brightness information, one or more chroma components (e.g., Cb and Cr) representing color information, and associated syntax elements, in which the luma and chroma components can have the same size of the basic processing unit. The luma and chroma components can be referred to as “coding tree blocks” (“CTBs”) in some video coding standards (e.g., H.265/HEVC or H.266/VVC). Any operation performed to a basic processing unit can be repeatedly performed to each of its luma and chroma components.

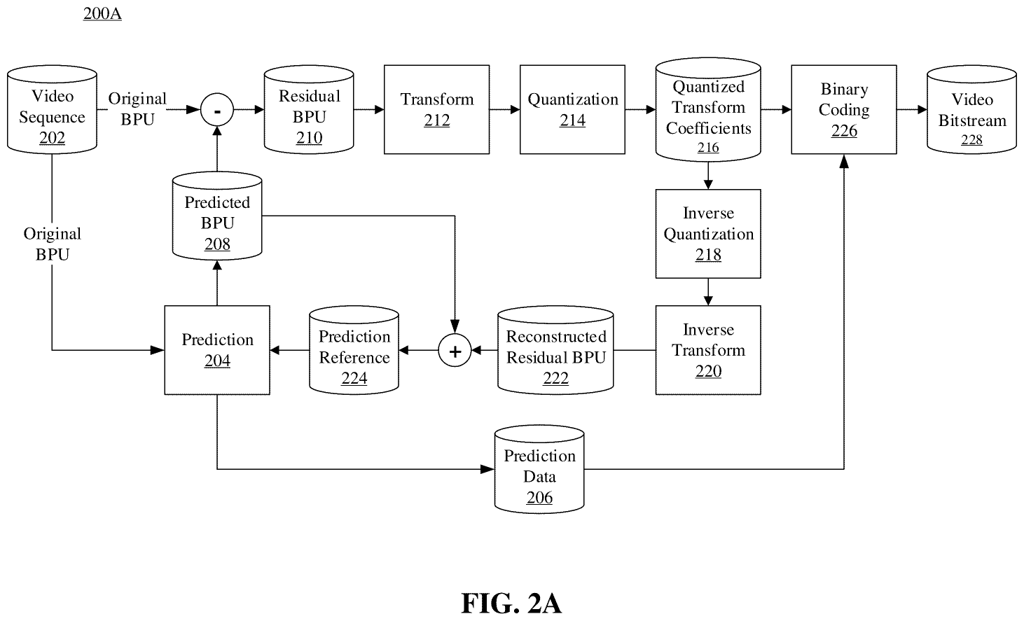

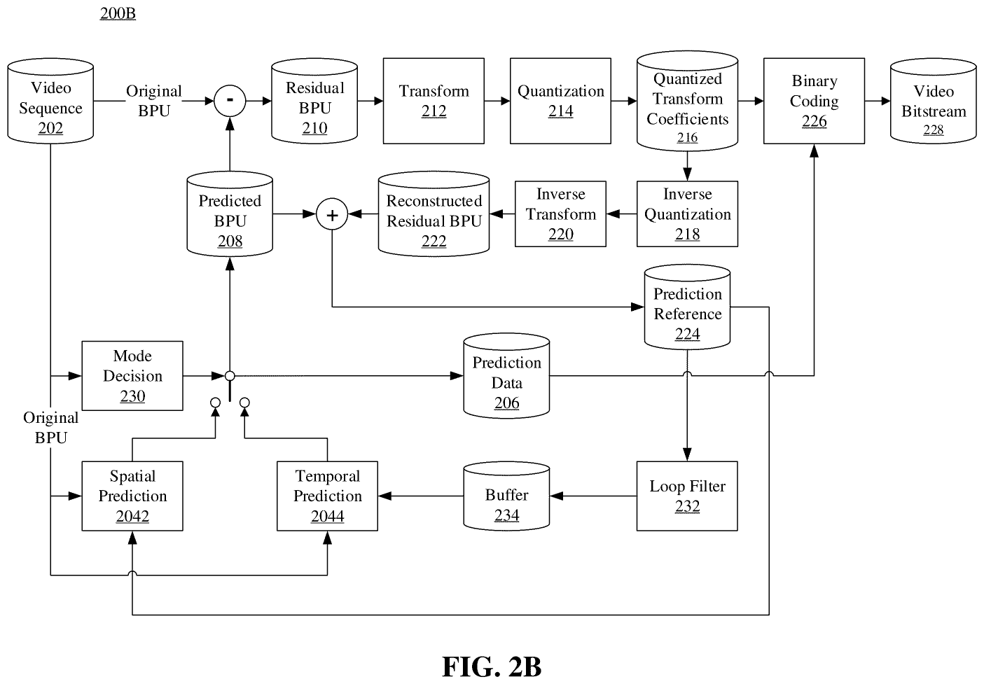

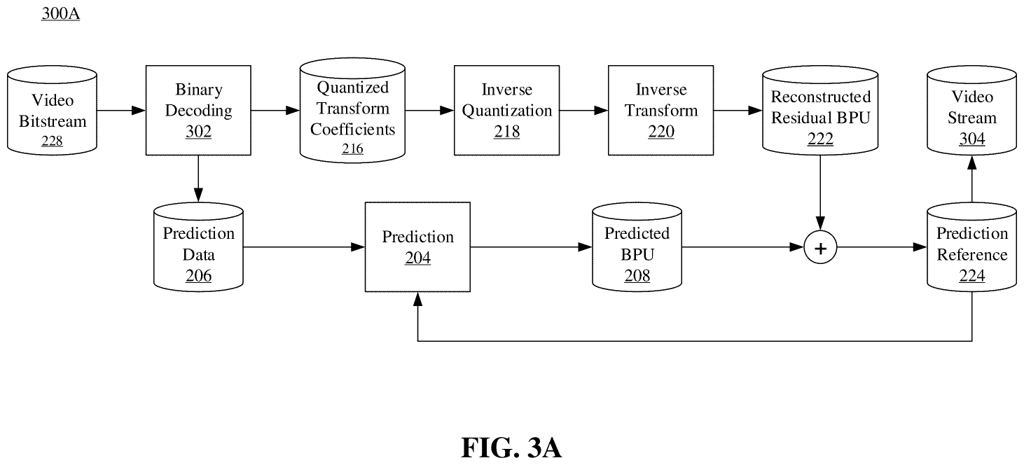

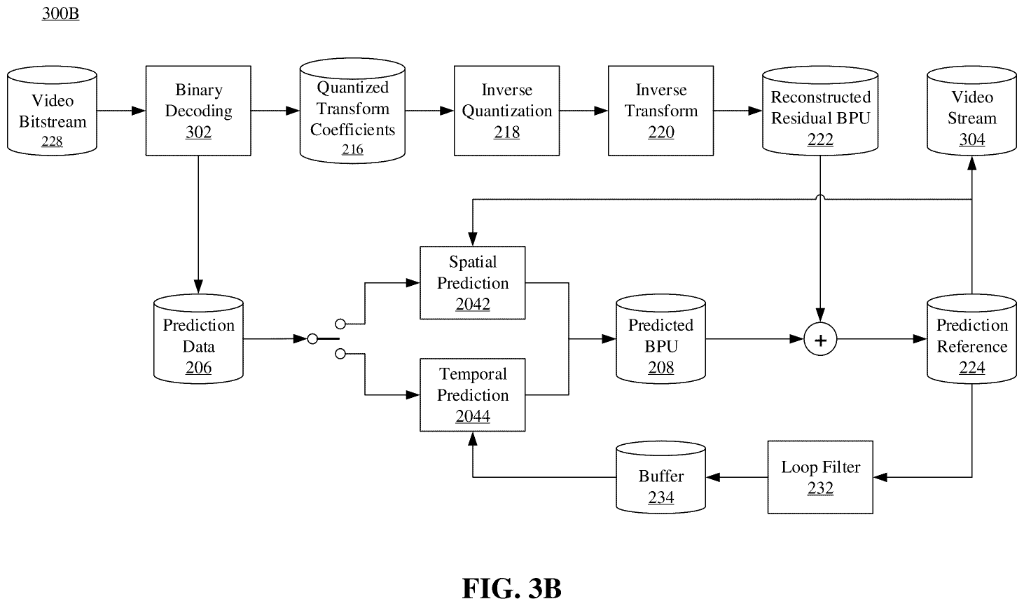

Video coding has multiple stages of operations, examples of which are shown in FIGS. 2A-2B and FIGS. 3A-3B. For each stage, the size of the basic processing units can still be too large for processing and thus can be further divided into segments referred to as “basic processing sub-units” in the present disclosure. In some embodiments, the basic processing sub-units can be referred to as “blocks” in some video coding standards (e.g., MPEG family, H.261, H.263, or H.264/AVC), or as “coding units” (“CUs”) in some other video coding standards (e.g., H.265/HEVC or H.266/VVC). A basic processing sub-unit can have the same or smaller size than the basic processing unit. Similar to the basic processing units, basic processing sub-units are also logical units, which can include a group of different types of video data (e.g., Y, Cb, Cr, and associated syntax elements) stored in a computer memory (e.g., in a video frame buffer). Any operation performed to a basic processing sub-unit can be repeatedly performed to each of its luma and chroma components. It should be noted that such division can be performed to further levels depending on processing needs. It should also be noted that different stages can divide the basic processing units using different schemes.

For example, at a mode decision stage (an example of which is shown in FIG. 2B), the encoder can decide what prediction mode (e.g., intra-picture prediction or inter-picture prediction) to use for a basic processing unit, which can be too large to make such a decision. The encoder can split the basic processing unit into multiple basic processing sub-units (e.g., CUs as in H.265/HEVC or H.266/VVC), and decide a prediction type for each individual basic processing sub-unit.

For another example, at a prediction stage (an example of which is shown in FIGS. 2A-2B), the encoder can perform prediction operation at the level of basic processing sub-units (e.g., CUs). However, in some cases, a basic processing sub-unit can still be too large to process. The encoder can further split the basic processing sub-unit into smaller segments (e.g., referred to as “prediction blocks” or “PBs” in H.265/HEVC or H.266/VVC), at the level of which the prediction operation can be performed.

For another example, at a transform stage (an example of which is shown in FIG. 2A and FIG. 2B), the encoder can perform a transform operation for residual basic processing sub-units (e.g., CUs). However, in some cases, a basic processing sub-unit can still be too large to process. The encoder can further split the basic processing sub-unit into smaller segments (e.g., referred to as “transform blocks” or “TBs” in H.265/HEVC or H.266/VVC), at the level of which the transform operation can be performed. It should be noted that the division schemes of the same basic processing sub-unit can be different at the prediction stage and the transform stage. For example, in H.265/HEVC or H.266/VVC, the prediction blocks and transform blocks of the same CU can have different sizes and numbers.

In structure 110 of FIG. 1, basic processing unit 112 is further divided into 3×3 basic processing sub-units, the boundaries of which are shown as dotted lines. Different basic processing units of the same picture can be divided into basic processing sub-units in different schemes.

In some implementations, to provide the capability of parallel processing and error resilience to video encoding and decoding, a picture can be divided into regions for processing, such that, for a region of the picture, the encoding or decoding process can depend on no information from any other region of the picture. In other words, each region of the picture can be processed independently. By doing so, the codec can process different regions of a picture in parallel, thus increasing the coding efficiency. Also, when data of a region is corrupted in the processing or lost in network transmission, the codec can correctly encode or decode other regions of the same picture without reliance on the corrupted or lost data, thus providing the capability of error resilience. In some video coding standards, a picture can be divided into different types of regions. For example, H.265/HEVC and H.266/VVC provide two types of regions: “slices” and “tiles.” It should also be noted that different pictures of video sequence 100 can have different partition schemes for dividing a picture into regions.

For example, in FIG. 1, structure 110 is divided into three regions 114, 116, and 118, the boundaries of which are shown as solid lines inside structure 110. Region 114 includes four basic processing units. Each of regions 116 and 118 includes six basic processing units. It should be noted that the basic processing units, basic processing sub-units, and regions of structure 110 in FIG. 1 are only examples, and the present disclosure does not limit embodiments thereof.

FIG. 2A illustrates a schematic diagram of an exemplary encoding process 200A, consistent with embodiments of the disclosure. For example, the encoding process 200A can be performed by an encoder. As shown in FIG. 2A, the encoder can encode video sequence 202 into video bitstream 228 according to process 200A. Similar to video sequence 100 in FIG. 1, video sequence 202 can include a set of pictures (referred to as “original pictures”) arranged in a temporal order. Similar to structure 110 in FIG. 1, each original picture of video sequence 202 can be divided by the encoder into basic processing units, basic processing sub-units, or regions for processing. In some embodiments, the encoder can perform process 200A at the level of basic processing units for each original picture of video sequence 202. For example, the encoder can perform process 200A in an iterative manner, in which the encoder can encode a basic processing unit in one iteration of process 200A. In some embodiments, the encoder can perform process 200A in parallel for regions (e.g., regions 114-118) of each original picture of video sequence 202.

In FIG. 2A, the encoder can feed a basic processing unit (referred to as an “original BPU”) of an original picture of video sequence 202 to prediction stage 204 to generate prediction data 206 and predicted BPU 208. The encoder can subtract predicted BPU 208 from the original BPU to generate residual BPU 210. The encoder can feed residual BPU 210 to transform stage 212 and quantization stage 214 to generate quantized transform coefficients 216. The encoder can feed prediction data 206 and quantized transform coefficients 216 to binary coding stage 226 to generate video bitstream 228. Components 202, 204, 206, 208, 210, 212, 214, 216, 226, and 228 can be referred to as a “forward path.” During process 200A, after quantization stage 214, the encoder can feed quantized transform coefficients 216 to inverse quantization stage 218 and inverse transform stage 220 to generate reconstructed residual BPU 222. The encoder can add reconstructed residual BPU 222 to predicted BPU 208 to generate prediction reference 224, which is used in prediction stage 204 for the next iteration of process 200A. Components 218, 220, 222, and 224 of process 200A can be referred to as a “reconstruction path.” The reconstruction path can be used to ensure that both the encoder and the decoder use the same reference data for prediction.

The encoder can perform process 200A iteratively to encode each original BPU of the original picture (in the forward path) and generate predicted reference 224 for encoding the next original BPU of the original picture (in the reconstruction path). After encoding all original BPUs of the original picture, the encoder can proceed to encode the next picture in video sequence 202.

Referring to process 200A, the encoder can receive video sequence 202 generated by a video capturing device (e.g., a camera). The term “receive” used herein can refer to receiving, inputting, acquiring, retrieving, obtaining, reading, accessing, or any action in any manner for inputting data.

At prediction stage 204, at a current iteration, the encoder can receive an original BPU and prediction reference 224 and perform a prediction operation to generate prediction data 206 and predicted BPU 208. Prediction reference 224 can be generated from the reconstruction path of the previous iteration of process 200A. The purpose of prediction stage 204 is to reduce information redundancy by extracting prediction data 206 that can be used to reconstruct the original BPU as predicted BPU 208 from prediction data 206 and prediction reference 224.

Ideally, predicted BPU 208 can be identical to the original BPU. However, due to non-ideal prediction and reconstruction operations, predicted BPU 208 is generally slightly different from the original BPU. For recording such differences, after generating predicted BPU 208, the encoder can subtract it from the original BPU to generate residual BPU 210. For example, the encoder can subtract values (e.g., greyscale values or RGB values) of pixels of predicted BPU 208 from values of corresponding pixels of the original BPU. Each pixel of residual BPU 210 can have a residual value as a result of such subtraction between the corresponding pixels of the original BPU and predicted BPU 208. Compared with the original BPU, prediction data 206 and residual BPU 210 can have fewer bits, but they can be used to reconstruct the original BPU without significant quality deterioration. Thus, the original BPU is compressed.

To further compress residual BPU 210, at transform stage 212, the encoder can reduce spatial redundancy of residual BPU 210 by decomposing it into a set of two-dimensional “base patterns,” each base pattern being associated with a “transform coefficient.” The base patterns can have the same size (e.g., the size of residual BPU 210). Each base pattern can represent a variation frequency (e.g., frequency of brightness variation) component of residual BPU 210. None of the base patterns can be reproduced from any combinations (e.g., linear combinations) of any other base patterns. In other words, the decomposition can decompose variations of residual BPU 210 into a frequency domain. Such a decomposition is analogous to a discrete Fourier transform of a function, in which the base patterns are analogous to the base functions (e.g., trigonometry functions) of the discrete Fourier transform, and the transform coefficients are analogous to the coefficients associated with the base functions.

Different transform algorithms can use different base patterns. Various transform algorithms can be used at transform stage 212, such as, for example, a discrete cosine transform, a discrete sine transform, or the like. The transform at transform stage 212 is invertible. That is, the encoder can restore residual BPU 210 by an inverse operation of the transform (referred to as an “inverse transform”). For example, to restore a pixel of residual BPU 210, the inverse transform can be multiplying values of corresponding pixels of the base patterns by respective associated coefficients and adding the products to produce a weighted sum. For a video coding standard, both the encoder and decoder can use the same transform algorithm (thus the same base patterns). Thus, the encoder can record only the transform coefficients, from which the decoder can reconstruct residual BPU 210 without receiving the base patterns from the encoder. Compared with residual BPU 210, the transform coefficients can have fewer bits, but they can be used to reconstruct residual BPU 210 without significant quality deterioration. Thus, residual BPU 210 is further compressed.

The encoder can further compress the transform coefficients at quantization stage 214. In the transform process, different base patterns can represent different variation frequencies (e.g., brightness variation frequencies). Because human eyes are generally better at recognizing low-frequency variation, the encoder can disregard information of high-frequency variation without causing significant quality deterioration in decoding. For example, at quantization stage 214, the encoder can generate quantized transform coefficients 216 by dividing each transform coefficient by an integer value (referred to as a “quantization scale factor”) and rounding the quotient to its nearest integer. After such an operation, some transform coefficients of the high-frequency base patterns can be converted to zero, and the transform coefficients of the low-frequency base patterns can be converted to smaller integers. The encoder can disregard the zero-value quantized transform coefficients 216, by which the transform coefficients are further compressed. The quantization process is also invertible, in which quantized transform coefficients 216 can be reconstructed to the transform coefficients in an inverse operation of the quantization (referred to as “inverse quantization”).

Because the encoder disregards the remainders of such divisions in the rounding operation, quantization stage 214 can be lossy. Typically, quantization stage 214 can contribute the most information loss in process 200A. The larger the information loss is, the fewer bits the quantized transform coefficients 216 can need. For obtaining different levels of information loss, the encoder can use different values of the quantization syntax element or any other syntax element of the quantization process.

At binary coding stage 226, the encoder can encode prediction data 206 and quantized transform coefficients 216 using a binary coding technique, such as, for example, entropy coding, variable length coding, arithmetic coding, Huffman coding, context-adaptive binary arithmetic coding, or any other lossless or lossy compression algorithm. In some embodiments, besides prediction data 206 and quantized transform coefficients 216, the encoder can encode other information at binary coding stage 226, such as, for example, a prediction mode used at prediction stage 204, syntax elements of the prediction operation, a transform type at transform stage 212, syntax elements of the quantization process (e.g., quantization syntax elements), an encoder control syntax element (e.g., a bitrate control syntax element), or the like. The encoder can use the output data of binary coding stage 226 to generate video bitstream 228. In some embodiments, video bitstream 228 can be further packetized for network transmission.

Referring to the reconstruction path of process 200A, at inverse quantization stage 218, the encoder can perform inverse quantization on quantized transform coefficients 216 to generate reconstructed transform coefficients. At inverse transform stage 220, the encoder can generate reconstructed residual BPU 222 based on the reconstructed transform coefficients. The encoder can add reconstructed residual BPU 222 to predicted BPU 208 to generate prediction reference 224 that is to be used in the next iteration of process 200A.

It should be noted that other variations of the process 200A can be used to encode video sequence 202. In some embodiments, stages of process 200A can be performed by the encoder in different orders. In some embodiments, one or more stages of process 200A can be combined into a single stage. In some embodiments, a single stage of process 200A can be divided into multiple stages. For example, transform stage 212 and quantization stage 214 can be combined into a single stage. In some embodiments, process 200A can include additional stages. In some embodiments, process 200A can omit one or more stages in FIG. 2A.

FIG. 2B illustrates a schematic diagram of another exemplary encoding process 200B, consistent with embodiments of the disclosure. Process 200B can be modified from process 200A. For example, process 200B can be used by an encoder conforming to a hybrid video coding standard (e.g., H.26x series). Compared with process 200A, the forward path of process 200B additionally includes mode decision stage 230 and divides prediction stage 204 into spatial prediction stage 2042 and temporal prediction stage 2044. The reconstruction path of process 200B additionally includes loop filter stage 232 and buffer 234.

Generally, prediction techniques can be categorized into two types: spatial prediction and temporal prediction. Spatial prediction (e.g., an intra-picture prediction or “intra prediction”) can use pixels from one or more already coded neighboring BPUs in the same picture to predict the current BPU. That is, prediction reference 224 in the spatial prediction can include the neighboring BPUs. The spatial prediction can reduce the inherent spatial redundancy of the picture. Temporal prediction (e.g., an inter-picture prediction or “inter prediction”) can use regions from one or more already coded pictures to predict the current BPU. That is, prediction reference 224 in the temporal prediction can include the coded pictures. The temporal prediction can reduce the inherent temporal redundancy of the pictures.

Referring to process 200B, in the forward path, the encoder performs the prediction operation at spatial prediction stage 2042 and temporal prediction stage 2044. For example, at spatial prediction stage 2042, the encoder can perform the intra prediction. For an original BPU of a picture being encoded, prediction reference 224 can include one or more neighboring BPUs that have been encoded (in the forward path) and reconstructed (in the reconstructed path) in the same picture. The encoder can generate predicted BPU 208 by extrapolating the neighboring BPUs. The extrapolation technique can include, for example, a linear extrapolation or interpolation, a polynomial extrapolation or interpolation, or the like. In some embodiments, the encoder can perform the extrapolation at the pixel level, such as by extrapolating values of corresponding pixels for each pixel of predicted BPU 208. The neighboring BPUs used for extrapolation can be located with respect to the original BPU from various directions, such as in a vertical direction (e.g., on top of the original BPU), a horizontal direction (e.g., to the left of the original BPU), a diagonal direction (e.g., to the down-left, down-right, up-left, or up-right of the original BPU), or any direction defined in the used video coding standard. For the intra prediction, prediction data 206 can include, for example, locations (e.g., coordinates) of the used neighboring BPUs, sizes of the used neighboring BPUs, syntax elements of the extrapolation, a direction of the used neighboring BPUs with respect to the original BPU, or the like.

For another example, at temporal prediction stage 2044, the encoder can perform the inter prediction. For an original BPU of a current picture, prediction reference 224 can include one or more pictures (referred to as “reference pictures”) that have been encoded (in the forward path) and reconstructed (in the reconstructed path). In some embodiments, a reference picture can be encoded and reconstructed BPU by BPU. For example, the encoder can add reconstructed residual BPU 222 to predicted BPU 208 to generate a reconstructed BPU. When all reconstructed BPUs of the same picture are generated, the encoder can generate a reconstructed picture as a reference picture. The encoder can perform an operation of “motion estimation” to search for a matching region in a scope (referred to as a “search window”) of the reference picture. The location of the search window in the reference picture can be determined based on the location of the original BPU in the current picture. For example, the search window can be centered at a location having the same coordinates in the reference picture as the original BPU in the current picture and can be extended out for a predetermined distance. When the encoder identifies (e.g., by using a pel-recursive algorithm, a block-matching algorithm, or the like) a region similar to the original BPU in the search window, the encoder can determine such a region as the matching region. The matching region can have different dimensions (e.g., being smaller than, equal to, larger than, or in a different shape) from the original BPU. Because the reference picture and the current picture are temporally separated in the timeline (e.g., as shown in FIG. 1), it can be deemed that the matching region “moves” to the location of the original BPU as time goes by. The encoder can record the direction and distance of such a motion as a “motion vector.” When multiple reference pictures are used (e.g., as picture 106 in FIG. 1), the encoder can search for a matching region and determine its associated motion vector for each reference picture. In some embodiments, the encoder can assign weights to pixel values of the matching regions of respective matching reference pictures.

The motion estimation can be used to identify various types of motions, such as, for example, translations, rotations, zooming, or the like. For inter prediction, prediction data 206 can include, for example, locations (e.g., coordinates) of the matching region, the motion vectors associated with the matching region, the number of reference pictures, weights associated with the reference pictures, or the like.

For generating predicted BPU 208, the encoder can perform an operation of “motion compensation.” The motion compensation can be used to reconstruct predicted BPU 208 based on prediction data 206 (e.g., the motion vector) and prediction reference 224. For example, the encoder can move the matching region of the reference picture according to the motion vector, in which the encoder can predict the original BPU of the current picture. When multiple reference pictures are used (e.g., as picture 106 in FIG. 1), the encoder can move the matching regions of the reference pictures according to the respective motion vectors and average pixel values of the matching regions. In some embodiments, if the encoder has assigned weights to pixel values of the matching regions of respective matching reference pictures, the encoder can add a weighted sum of the pixel values of the moved matching regions.

In some embodiments, the inter prediction can be unidirectional or bidirectional. Unidirectional inter predictions can use one or more reference pictures in the same temporal direction with respect to the current picture. For example, picture 104 in FIG. 1 is a unidirectional inter-predicted picture, in which the reference picture (e.g., picture 102) precedes picture 104. Bidirectional inter predictions can use one or more reference pictures at both temporal directions with respect to the current picture. For example, picture 106 in FIG. 1 is a bidirectional inter-predicted picture, in which the reference pictures (e.g., pictures 104 and 108) are at both temporal directions with respect to picture 104.

Still referring to the forward path of process 200B, after spatial prediction 2042 and temporal prediction stage 2044, at mode decision stage 230, the encoder can select a prediction mode (e.g., one of the intra prediction or the inter prediction) for the current iteration of process 200B. For example, the encoder can perform a rate-distortion optimization technique, in which the encoder can select a prediction mode to minimize a value of a cost function depending on a bit rate of a candidate prediction mode and distortion of the reconstructed reference picture under the candidate prediction mode. Depending on the selected prediction mode, the encoder can generate the corresponding predicted BPU 208 and predicted data 206.

In the reconstruction path of process 200B, if intra prediction mode has been selected in the forward path, after generating prediction reference 224 (e.g., the current BPU that has been encoded and reconstructed in the current picture), the encoder can directly feed prediction reference 224 to spatial prediction stage 2042 for later usage (e.g., for extrapolation of a next BPU of the current picture). The encoder can feed prediction reference 224 to loop filter stage 232, at which the encoder can apply a loop filter to prediction reference 224 to reduce or eliminate distortion (e.g., blocking artifacts) introduced during coding of the prediction reference 224. The encoder can apply various loop filter techniques at loop filter stage 232, such as, for example, deblocking, sample adaptive offsets, adaptive loop filters, or the like. The loop-filtered reference picture can be stored in buffer 234 (or “decoded picture buffer (DPB)”) for later use (e.g., to be used as an inter-prediction reference picture for a future picture of video sequence 202). The encoder can store one or more reference pictures in buffer 234 to be used at temporal prediction stage 2044. In some embodiments, the encoder can encode syntax elements of the loop filter (e.g., a loop filter strength) at binary coding stage 226, along with quantized transform coefficients 216, prediction data 206, and other information.

FIG. 3A illustrates a schematic diagram of an exemplary decoding process 300A, consistent with embodiments of the disclosure. Process 300A can be a decompression process corresponding to the compression process 200A in FIG. 2A. In some embodiments, process 300A can be similar to the reconstruction path of process 200A. A decoder can decode video bitstream 228 into video stream 304 according to process 300A. Video stream 304 can be very similar to video sequence 202. However, due to the information loss in the compression and decompression process (e.g., quantization stage 214 in FIG. 2A and FIG. 2B), generally, video stream 304 is not identical to video sequence 202. Similar to processes 200A and 200B in FIG. 2A and FIG. 2B, the decoder can perform process 300A at the level of basic processing units (BPUs) for each picture encoded in video bitstream 228. For example, the decoder can perform process 300A in an iterative manner, in which the decoder can decode a basic processing unit in one iteration of process 300A. In some embodiments, the decoder can perform process 300A in parallel for regions (e.g., regions 114-118) of each picture encoded in video bitstream 228.

In FIG. 3A, the decoder can feed a portion of video bitstream 228 associated with a basic processing unit (referred to as an “encoded BPU”) of an encoded picture to binary decoding stage 302. At binary decoding stage 302, the decoder can decode the portion into prediction data 206 and quantized transform coefficients 216. The decoder can feed quantized transform coefficients 216 to inverse quantization stage 218 and inverse transform stage 220 to generate reconstructed residual BPU 222. The decoder can feed prediction data 206 to prediction stage 204 to generate predicted BPU 208. The decoder can add reconstructed residual BPU 222 to predicted BPU 208 to generate predicted reference 224. In some embodiments, predicted reference 224 can be stored in a buffer (e.g., a decoded picture buffer in a computer memory). The decoder can feed predicted reference 224 to prediction stage 204 for performing a prediction operation in the next iteration of process 300A.

The decoder can perform process 300A iteratively to decode each encoded BPU of the encoded picture and generate predicted reference 224 for encoding the next encoded BPU of the encoded picture. After decoding all encoded BPUs of the encoded picture, the decoder can output the picture to video stream 304 for display and proceed to decode the next encoded picture in video bitstream 228.

At binary decoding stage 302, the decoder can perform an inverse operation of the binary coding technique used by the encoder (e.g., entropy coding, variable length coding, arithmetic coding, Huffman coding, context-adaptive binary arithmetic coding, or any other lossless compression algorithm). In some embodiments, besides prediction data 206 and quantized transform coefficients 216, the decoder can decode other information at binary decoding stage 302, such as, for example, a prediction mode, syntax elements of the prediction operation, a transform type, syntax elements of the quantization process (e.g., quantization syntax elements), an encoder control syntax element (e.g., a bitrate control syntax element), or the like. In some embodiments, if video bitstream 228 is transmitted over a network in packets, the decoder can depacketize video bitstream 228 before feeding it to binary decoding stage 302.

FIG. 3B illustrates a schematic diagram of another exemplary decoding process 300B, consistent with embodiments of the disclosure. Process 300B can be modified from process 300A. For example, process 300B can be used by a decoder conforming to a hybrid video coding standard (e.g., H.26x series). Compared with process 300A, process 300B additionally divides prediction stage 204 into spatial prediction stage 2042 and temporal prediction stage 2044 and additionally includes loop filter stage 232 and buffer 234.

In process 300B, for an encoded basic processing unit (referred to as a “current BPU”) of an encoded picture (referred to as a “current picture”) that is being decoded, prediction data 206 decoded from binary decoding stage 302 by the decoder can include various types of data, depending on what prediction mode was used to encode the current BPU by the encoder. For example, if intra prediction was used by the encoder to encode the current BPU, prediction data 206 can include a prediction mode indicator (e.g., a flag value) indicative of the intra prediction, syntax elements of the intra prediction operation, or the like. The syntax elements of the intra prediction operation can include, for example, locations (e.g., coordinates) of one or more neighboring BPUs used as a reference, sizes of the neighboring BPUs, syntax elements of extrapolation, a direction of the neighboring BPUs with respect to the original BPU, or the like. For another example, if inter prediction was used by the encoder to encode the current BPU, prediction data 206 can include a prediction mode indicator (e.g., a flag value) indicative of the inter prediction, syntax elements of the inter prediction operation, or the like. The syntax elements of the inter prediction operation can include, for example, the number of reference pictures associated with the current BPU, weights respectively associated with the reference pictures, locations (e.g., coordinates) of one or more matching regions in the respective reference pictures, one or more motion vectors respectively associated with the matching regions, or the like.

Based on the prediction mode indicator, the decoder can decide whether to perform a spatial prediction (e.g., the intra prediction) at spatial prediction stage 2042 or a temporal prediction (e.g., the inter prediction) at temporal prediction stage 2044. The details of performing such spatial prediction or temporal prediction are described in FIG. 2B and will not be repeated hereinafter. After performing such spatial prediction or temporal prediction, the decoder can generate predicted BPU 208. The decoder can add predicted BPU 208 and reconstructed residual BPU 222 to generate prediction reference 224, as described in FIG. 3A.

In process 300B, the decoder can feed predicted reference 224 to spatial prediction stage 2042 or temporal prediction stage 2044 for performing a prediction operation in the next iteration of process 300B. For example, if the current BPU is decoded using the intra prediction at spatial prediction stage 2042, after generating prediction reference 224 (e.g., the decoded current BPU), the decoder can directly feed prediction reference 224 to spatial prediction stage 2042 for later usage (e.g., for extrapolation of a next BPU of the current picture). If the current BPU is decoded using the inter prediction at temporal prediction stage 2044, after generating prediction reference 224 (e.g., a reference picture in which all BPUs have been decoded), the decoder can feed prediction reference 224 to loop filter stage 232 to reduce or eliminate distortion (e.g., blocking artifacts). The decoder can apply a loop filter to prediction reference 224, in a way as described in FIG. 2B. The loop-filtered reference picture can be stored in buffer 234 (e.g., a decoded picture buffer (DPB) in a computer memory) for later use (e.g., to be used as an inter-prediction reference picture for a future encoded picture of video bitstream 228). The decoder can store one or more reference pictures in buffer 234 to be used at temporal prediction stage 2044. In some embodiments, prediction data can further include syntax elements of the loop filter (e.g., a loop filter strength). In some embodiments, prediction data includes syntax elements of the loop filter when the prediction mode indicator of prediction data 206 indicates that inter prediction was used to encode the current BPU.

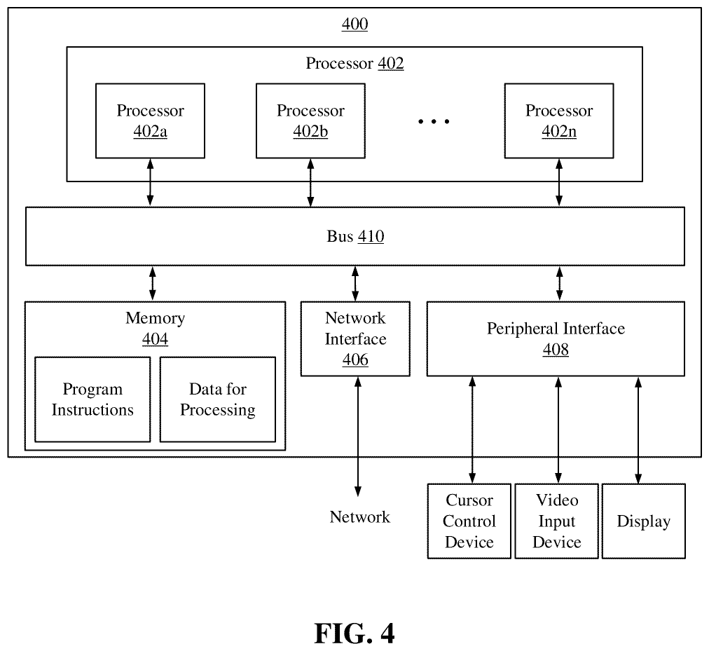

FIG. 4 is a block diagram of an exemplary apparatus 400 for encoding or decoding a video, consistent with embodiments of the disclosure. As shown in FIG. 4, apparatus 400 can include processor 402. When processor 402 executes instructions described herein, apparatus 400 can become a specialized machine for video encoding or decoding. Processor 402 can be any type of circuitry capable of manipulating or processing information. For example, processor 402 can include any combination of any number of a central processing unit (or “CPU”), a graphics processing unit (or “GPU”), a neural processing unit (“NPU”), a microcontroller unit (“MCU”), an optical processor, a programmable logic controller, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), or the like. In some embodiments, processor 402 can also be a set of processors grouped as a single logical component. For example, as shown in FIG. 4, processor 402 can include multiple processors, including processor 402a, processor 402b, and processor 402n.

Apparatus 400 can also include memory 404 configured to store data (e.g., a set of instructions, computer codes, intermediate data, or the like). For example, as shown in FIG. 4, the stored data can include program instructions (e.g., program instructions for implementing the stages in processes 200A, 200B, 300A, or 300B) and data for processing (e.g., video sequence 202, video bitstream 228, or video stream 304). Processor 402 can access the program instructions and data for processing (e.g., via bus 410), and execute the program instructions to perform an operation or manipulation on the data for processing. Memory 404 can include a high-speed random-access storage device or a non-volatile storage device. In some embodiments, memory 404 can include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or the like. Memory 404 can also be a group of memories (not shown in FIG. 4) grouped as a single logical component.

Bus 410 can be a communication device that transfers data between components inside apparatus 400, such as an internal bus (e.g., a CPU-memory bus), an external bus (e.g., a universal serial bus port, a peripheral component interconnect express port), or the like.

For ease of explanation without causing ambiguity, processor 402 and other data processing circuits are collectively referred to as a “data processing circuit” in this disclosure. The data processing circuit can be implemented entirely as hardware, or as a combination of software, hardware, or firmware. In addition, the data processing circuit can be a single independent module or can be combined entirely or partially into any other component of apparatus 400.

Apparatus 400 can further include network interface 406 to provide wired or wireless communication with a network (e.g., the Internet, an intranet, a local area network, a mobile communications network, or the like). In some embodiments, network interface 406 can include any combination of any number of a network interface controller (NIC), a radio frequency (RF) module, a transponder, a transceiver, a modem, a router, a gateway, a wired network adapter, a wireless network adapter, a Bluetooth adapter, an infrared adapter, a near-field communication (“NFC”) adapter, a cellular network chip, or the like.

In some embodiments, optionally, apparatus 400 can further include peripheral interface 408 to provide a connection to one or more peripheral devices. As shown in FIG. 4, the peripheral device can include, but is not limited to, a cursor control device (e.g., a mouse, a touchpad, or a touchscreen), a keyboard, a display (e.g., a cathode-ray tube display, a liquid crystal display, or a light-emitting diode display), a video input device (e.g., a camera or an input interface coupled to a video archive), or the like.

It should be noted that video codecs (e.g., a codec performing process 200A, 200B, 300A, or 300B) can be implemented as any combination of any software or hardware modules in apparatus 400. For example, some or all stages of process 200A, 200B, 300A, or 300B can be implemented as one or more software modules of apparatus 400, such as program instructions that can be loaded into memory 404. For another example, some or all stages of process 200A, 200B, 300A, or 300B can be implemented as one or more hardware modules of apparatus 400, such as a specialized data processing circuit (e.g., an FPGA, an ASIC, an NPU, or the like).

In VVC, a coding tree unit (CTU) can be as large as 128×128 and may be further partitioned into coding units (CU) using quad-tree, binary tree, or ternary tree. The CU is then predicted using either intra or inter prediction. If intra prediction is used, the CU is predicted using spatial neighboring samples with 67 intra prediction modes (e.g., DC mode, planar mode, or 65 angular modes), cross-component linear model prediction, multiple reference line intra prediction, intra sub-partitions or matrix weighted intra prediction modes. If inter prediction is used, the CU is predicted using samples of reference pictures with merge mode, merge mode with motion vector difference (MMVD), geometric partition mode (GPM), combined inter and intra prediction (CIIP), bi-prediction with CU-level weight (BCW), adaptive motion vector resolution, affine motion compensation prediction, subblock-based temporal motion vector prediction, bi-directional optical flow, decoder-side motion vector refinement or symmetric motion vector difference coding modes. After either intra or inter prediction, the residues are transformed and quantized. In VVC, multiple transform cores including DCT-II, DCT-VIII and DST-VII are supported. Besides, larger block-size transform with zero-out for high frequency components and subblock transform are used. For quantization, dependent quantization and joint coding of chroma residuals are introduced in VVC. Finally, the prediction samples and the residues are added together to generate reconstructed samples, which are filtered using deblocking filter, sample adaptive offset, adaptive loop filter and/or luma mapping with chroma scaling.

After VVC, the JVET starts to explore coding techniques beyond VVC using an Enhanced Compression Model (ECM). In ECM, most coding tools in VVC are further investigated and more new tools are introduced, such as decoder side intra mode derivation, template-based intra mode derivation, convolutional cross-component intra prediction model, spatial geometric partitioning mode, local illumination compensation (LIC), template matching (TM), Overlapped Block Motion Compensation (OBMC), etc. Compared to the reference software of VVC (VTM-11.0), the ECM may achieve 24.01% and 19.02% luma BD-rate reduction under random access and low-delay B configurations, respectively.

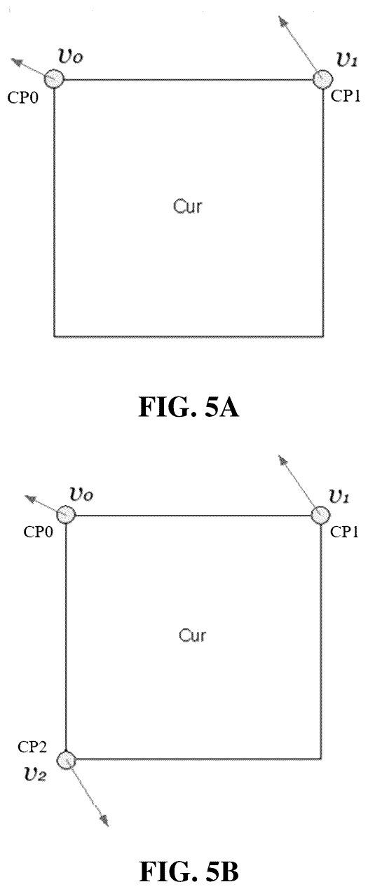

In HEVC, only translation motion model is applied for motion compensation prediction (MCP). While in the real world, there are many kinds of motions, e.g. zoom in/out, rotation, perspective motions and other irregular motions. In VVC, a block-based affine transform motion compensation prediction is applied. FIG. 5A and FIG. 5B illustrate exemplary control point based affine motion models, according to some embodiments of the present disclosure. As shown FIG. 5A and FIG. 5B, the affine motion field of the block is described by motion information of two control point (4-parameter) as shown in FIG. 5A or three control point motion vectors (6-parameter) as shown in FIG. 5B.

For 4-parameter affine motion model, as shown in FIG. 5A, motion vector at sample location (x, y) in a block is derived as:

$$\{ \begin{matrix}{mv}_{x} = \frac{{mv}_{1 x} - {mv}_{0 x}}{W} x + \frac{{mv}_{1 y} - {mv}_{0 y}}{W} y + {mv}_{0 x} \\ {mv}_{y} = \frac{{mv}_{1 y} - {mv}_{0 y}}{W} x + \frac{{mv}_{1 y} - {mv}_{0 x}}{W} y + {mv}_{0 y}\end{matrix} \qquad ( 1 )$$

For 6-parameter affine motion model, as shown in FIG. 5B, motion vector at sample location (x, y) in a block is derived as:

$$\{ \begin{matrix}{mv}_{x} = \frac{{mv}_{1 x} - {mv}_{0 x}}{W} x + \frac{{mv}_{2 x} - {mv}_{0 x}}{H} y + {mv}_{0 x} \\ {mv}_{y} = \frac{{mv}_{1 y} - {mv}_{0 y}}{W} x + \frac{{mv}_{2 y} - {mv}_{0 y}}{H} y + {mv}_{0 y}\end{matrix} \qquad ( 2 )$$

where (mv₀ₓ, mv_{0y}) is motion vector v₀ of the top-left corner control point CP0, (mv₁ₓ, mv_{1y}) is motion vector v₁ of the top-right corner control point CP1, and (mv₂ₓ, mv_{2y}) is motion vector v₂ of the bottom-left corner control point CP2.

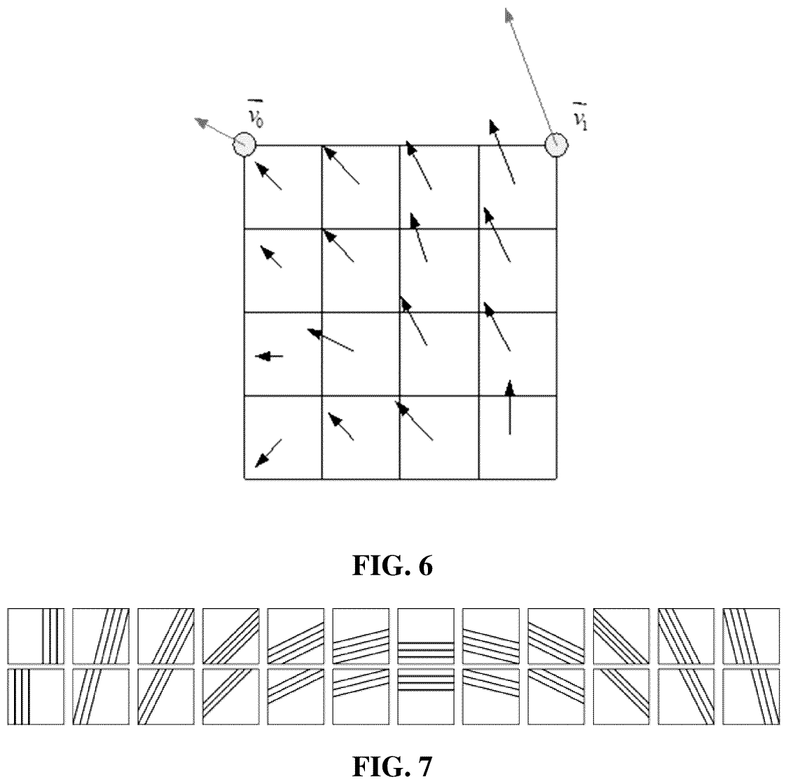

In order to simplify the motion compensation prediction, block based affine transform prediction is applied. FIG. 6 illustrates exemplary affine motion vector field (MVF) per subblock, according to some embodiments of the present disclosure. To derive motion vector of each 4×4 luma subblock, the motion vector of the center sample of each subblock is calculated according to above equations (1) and (2) and rounded to 1/16 fraction accuracy. Then the motion compensation interpolation filters are applied to generate the prediction of each subblock with derived motion vector. The subblock size of chroma-components is also set to be 4×4. The MV of a 4×4 chroma subblock is calculated as the average of the MVs of the top-left and bottom-right luma subblocks in the collocated 8×8 luma region.

As done for translational motion inter prediction, there are also two affine motion inter prediction modes: affine merge mode and affine advance motion vector prediction (AMVP) mode.

In VVC, GPM is supported for inter prediction. The GPM is signaled using a CU-level flag as one kind of merge mode, with other merge modes including the regular merge mode, the MMVD mode, the CIIP mode and the subblock merge mode. In total 64 partitions are supported by geometric partitioning mode for each possible CU size w×h=2^{m}×2ⁿ with m, n∈{3 . . . 6} excluding 8×64 and 64×8.

FIG. 7 illustrates examples of geometric partition mode (GPM) splits grouped by identical angles, according to some embodiments of the present disclosure. When GPM is used, a CU is split into two parts by a geometrically located straight line as shown in FIG. 7. The location of the splitting line is mathematically derived from the angle and offset parameters of a specific partition. Each part of a geometric partition in the CU is inter-predicted using its own motion. Only uni-prediction is allowed for each partition, that is, each part has one motion vector and one reference index. The uni-prediction motion constraint is applied to ensure that same as the conventional bi-prediction, only two motion compensated predictions are needed for each CU. The uni-prediction motion for each partition is derived using the process described in detail below. In ECM, the GPM is further extended to enable bi-predictive motion vectors and affine motion compensation.

If geometric partitioning mode is used for the current CU, then a geometric partition index indicating the partition mode of the geometric partition (angle and offset), and two merge indices (one for each partition) are further signaled. The number of maximum GPM candidate size is signaled explicitly in sequence parameter set (SPS) and specifies syntax binarization for GPM merge indices. After predicting each of parts of the geometric partition, the sample values along the geometric partition edge are adjusted using a blending processing with adaptive weights. In ECM, the blending process in ECM is improved by adding four extra blending area sizes. This is the prediction signal for the whole CU, and transform and quantization process will be applied to the whole CU as in other prediction modes. In addition, regression GPM (also referred as implicit GPM) is proposed to derive blending matrices implicitly in ECM. Finally, the motion field of a CU predicted using the geometric partition modes is stored.

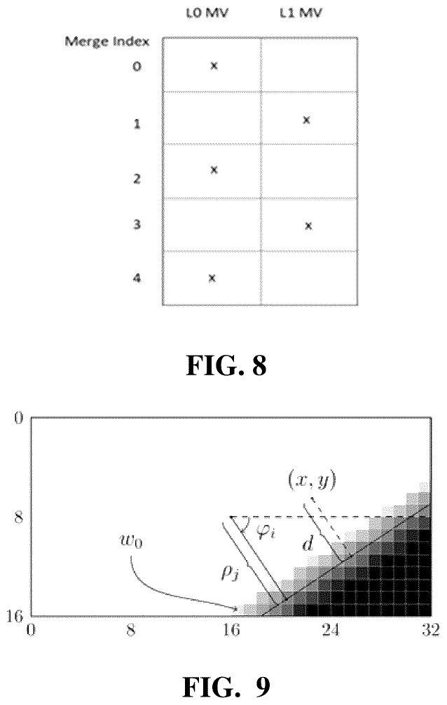

For uni-prediction candidate list construction, the uni-prediction candidate list is derived directly from the merge candidate list constructed for regular merge mode. Denote n as the index of the uni-prediction motion in the geometric uni-prediction candidate list. FIG. 8 illustrates exemplary uni-prediction MV selection for geometric partitioning mode, according to some embodiments of the present disclosure. The LX motion vector of the n-th extended merge candidate, with X equal to the parity of n, is used as the n-th uni-prediction motion vector for geometric partitioning mode. These motion vectors are marked with “x” in FIG. 8. In case a corresponding LX motion vector of the n-the extended merge candidate does not exist, the L(1-X) motion vector of the same candidate is used instead as the uni-prediction motion vector for geometric partitioning mode.

The GPM design in VVC relies on uni-predictive motion vectors to generate motion compensated prediction samples for each inter GPM partition. In ECM, such a design has been extended to allow usage of bi-predictive motion vectors.

When constructing a GPM candidate list, the extraction process that extracts uni-predictive motion vectors from the initial merge candidate list is invoked only for small blocks 8×8, 16×8 and 8×16. For larger blocks, the extraction process is bypassed, so the initial merge candidate list (which may contain merged Bi-MVs) is directly used as the final GPM merge candidate list. The generation of the initial merge candidate list is the same as before (i.e., the normal merge candidate list generation without any candidate reordering) except that when generating the initial merge candidate list for larger blocks (i.e., blocks with the extraction process bypassed), the motion vector difference threshold for controlling whether a candidate can be added into the list is increased to be one full sample distance.

Bi-directional optical flow (BDOF) based motion vector refinement as in the multi-pass Decoder side Motion Vector Refinement (DMVR) is used when generating motion compensated prediction samples.

When GPM-MMVD is used for a GPM partition and its base motion vector is bi-predictive, for low-delay pictures, the signaled motion vector difference (MVD) is applied on top of the L0 and L1 motion vector as in the existing merge MMVD design. For non-low-delay pictures, the bi-predictive motion vector is converted into a uni-predictive motion vector first and then the MVD is applied on top.

In ECM, the GPM is further extended to enable affine motion compensation (AMC). Therefore, a GPM partition can be predicted by AMC inter-prediction, non-AMC inter-prediction or intra-prediction. In addition, a GPM partition predicted by AMC can be combined with the other GPM partition predicted by AMC, non-AMC, or intra-prediction.

When AMC is applied, a uni-prediction affine merge candidate list is constructed from the subblock-based merge candidate list after discarding subblock-based temporal motion vector prediction (SbTMVP) candidates, similar to the uni-prediction merge candidate list construction for GPM in VVC. AMC is performed for a GPM partition using the control point motion vectors (CPMVs) of a merge candidate in the uni-prediction affine merge candidate list. The length of the uni-prediction affine merge candidate list is signaled in SPS. When ARMC is applicable, the uni-prediction affine merge candidate list is reordered according to the template costs.

A gpm_affine_flag is signaled for each GPM partition to indicate whether AMC is applied for the GPM partition. A merge candidate index for the GPM partition is signaled using individual arithmetic context models depending on whether AMC or non-AMC is applied.

AMC is not allowed for GPM-MMVD and GPM-TM.

Next, blending along the geometric partitioning edge is proposed. After predicting each part of a geometric partition using its own motion, blending is applied to the two prediction signals to derive samples around geometric partition edge. The blending weights for each position of the CU are derived based on the distance between individual position and the partition edge.

The distance for a position (x, y) to the partition edge is derived as:

$$d ( x , y ) = ( 2 x + 1 - w ) cos ( {φ}_{i} ) + ( 2 y + 1 - h ) sin ( {φ}_{i} ) - {ρ}_{j} \qquad ( 3 )$$

$${ρ}_{j} = {ρ}_{x , j} cos ( {φ}_{i} ) + {ρ}_{y , j} sin ( {φ}_{i} ) \qquad ( 4 )$$

$${ρ}_{x , j} = \{ \begin{matrix}0 & i \% 16 = 8 or ( 1 \% 16 \neq 0 and h \geq w ) \\ \pm ( 1 \times w ) >> 2 & otherwise\end{matrix} \qquad ( 5 )$$

$${ρ}_{y , j} = \{ \begin{matrix}\pm ( 1 \times h ) >> 2 & i \% 16 = 8 or ( 1 \% 16 \neq 0 and h \geq w ) \\ 0 & otherwise\end{matrix} \qquad ( 6 )$$

where i, j are the indices for angle and offset of a geometric partition, which depend on the signaled geometric partition index. The sign of ρ_{x,j} and ρ_{y,j} depend on angle index i.

The weights for each part of a geometric partition are derived as following:

$$wIdxL ( x , y ) = partIdx ? 32 + d ( x , y ) : 32 - d ( x , y ) \qquad ( 7 )$$

$${w}_{0} ( x , y ) = \frac{Clip 3 ( 0 , 8 , ( wIdx L ( x , y ) + 4 ) >> 3 )}{8} \qquad ( 8 )$$

$${w}_{1} ( x , y ) = 1 - {w}_{0} ( x , y ) \qquad ( 9 )$$

FIG. 9 illustrates an exemplary generation of a bending weight w₀ using geometric partitioning mode, according to some embodiments of the present disclosure. The partIdx depends on the angle index i.

Next, geometric partitioning mode (GPM) with adaptive blending is proposed. In VVC, the final prediction samples are generated by blending the prediction of the two prediction signals using weighted average. Two integer blending matrices (W0 and W1) are used. The weights in the GPM blending matrices are derived from the ramp function based on the displacement from a predicted sample position to the GPM partitioning boundary. The blending area size is fixed to two (e.g., two samples on each side of the GPM partition split boundary).

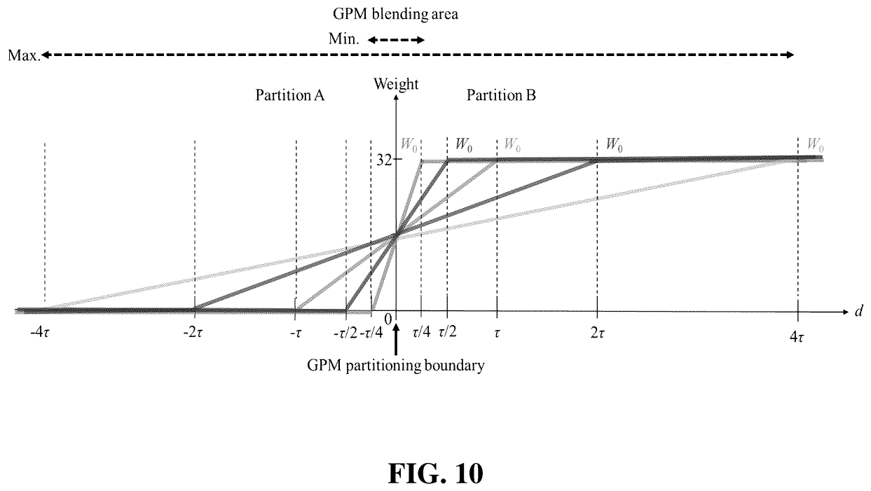

FIG. 10 illustrates a ramp function for the weights for GPM blending based on the displacement (d) from a predicted sample position to the GPM partitioning boundary and the blending area size (t), according to some embodiments of the present disclosure. The blending process in ECM is improved by adding four extra blending area sizes (e.g., quarter, half, double, and quadrupole of the existing area size) as shown in FIG. 10. A CU level flag is coded to signal the selected blending area size and signaled. Furthermore, the extended weighting precision is utilized, in which the maximum value of the weighs is changed from 8 (in VVC) to 32 to accommodate the extended blending area sizes.

Regression GPM (also referred as implicit GPM) is also proposed. In the regression GPM, the two integer blending matrices (W0 and W1) are derived from the template (1 line above, 1 column left). The blending matrices are modelled as an affine linear function of the sample positions (x, y) in the current CU:

$$W 0 ( x , y ) = a x + b y + c and W 1 ( x , y ) = 1 - w 0 ( x , y ) .$$

The parameters (a, b, c) are derived from the reference template using the same solver (mean squared error (MSE) minimization) as the one used for convolutional cross-component model (CCCM), gradient linear model (GLM) or gradient linear convolutional cross-component model GL-CCCM. A list of pairs of candidates is built from the regular GPM candidates and re-ordered with the template cost.

The regression GPM is signaled by a CU-level flag (e.g., gpm_implicit_flag). If gpm_implicit_flag is true which indicates the GPM is enabled for the CU, a merge-idx is coded to signal the pair of GPM candidates to be used. If gpm_implicit_flag is false which indicates the GPM is disabled for the CU, the regular GPM syntax elements are signaled.

A first motion vector (Mv1) from the first part of the geometric partition, a second motion vector (Mv2) from the second part of the geometric partition and a combined motion vector Mv of Mv1 and Mv2 are stored in the motion filed of a geometric partitioning mode coded CU.

The stored motion vector type for each individual position in the motion filed are determined as:

$$sType = abs ( motionIdx ) < 32 ? 2 : ( motionIdx \leq 0 ? ( 1 - partIdx ) : partIdx ) \qquad ( 10 )$$

where motionIdx is equal to d (4x+2, 4y+2), which is recalculated from equation (1). The partIdx depends on the angle index i.

If sType is equal to 0 or 1, Mv0 or Mv1 are stored in the corresponding motion field, otherwise if sType is equal to 2, a combined Mv from Mv0 and Mv2 are stored. The combined Mv are generated using the following process:
1) If Mv1 and Mv2 are from different reference picture lists (one from L0 and the other from L1), then Mv1 and Mv2 are simply combined to form the bi-prediction motion vectors.
2) Otherwise, if Mv1 and Mv2 are from the same list, only uni-prediction motion Mv2 is stored.

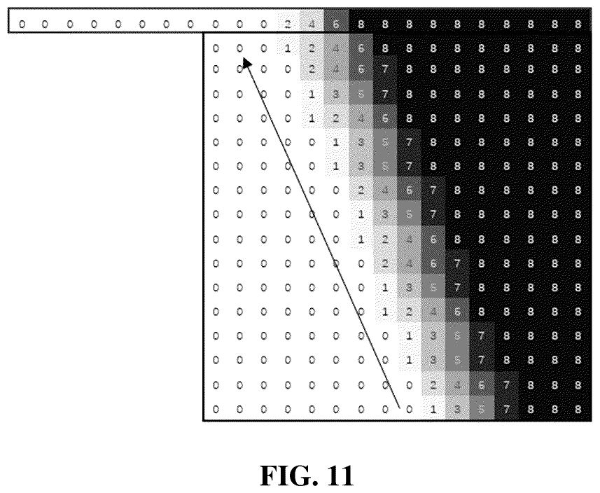

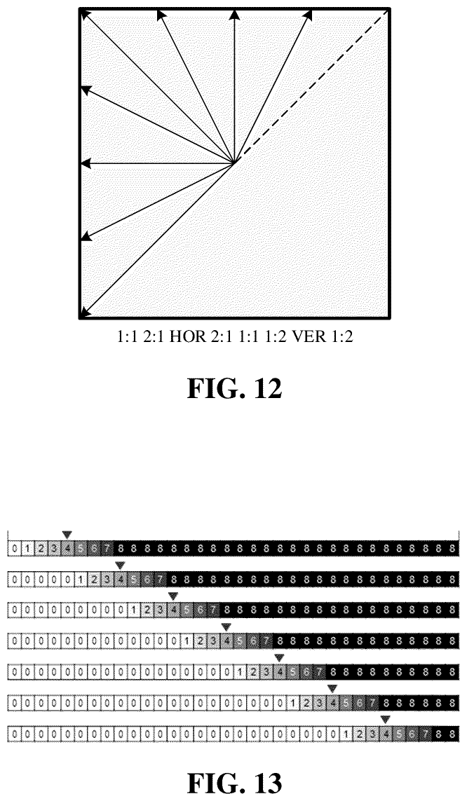

Similar to GPM in VVC, one tool called angular weighted prediction (AWP) is adopted in Audio Video coding Standard 3 (AVS3). AVS3 video standard is developed by AVS Workgroup which was founded in 2002 in China. In AVS3, an angular weighted prediction mode is supported for skip and direct mode. The AWP mode is signalled using a CU-level flag as one kind of skip or direct mode. In the AWP mode, a motion vector candidate list, which contains five different uni-prediction motion vectors, is firstly constructed by deriving motion vectors from spatial neighboring blocks and temporal motion vector predictor. Secondly, two uni-prediction motion vectors are selected from the motion vector candidate list to predict the current block. Unlike the bi-prediction inter mode which has equal weights for all samples, each sample coded in AWP mode may have different weights. The weight for each sample is predicted from a weight array which has values from 0 to 8. FIG. 11 illustrates an example for AWP weight prediction, according to some embodiments of the present disclosure. FIG. 12 illustrates eight intra prediction angles supported in the AWP mode, according to some embodiments of the present disclosure. FIG. 13 illustrates seven different weight array settings in the AWP mode, according to some embodiments of the present disclosure. The weight prediction is similar to the process of intra prediction mode, as shown in FIG. 11. In total 56 different kinds of weights are supported by AWP mode for each possible CU size w×h=2^{m}×2ⁿ with m, n∈{3 . . . 6}, including 8 intra prediction angles as shown in FIGS. 12 and 7 different weight array settings as shown in FIG. 13. It is noted that the AWP mode is directly signaled to decoder without prediction. The AWP mode index is binarized using truncated binary, that is, index 0 to 7 are coded using 5 bits and index 8 to 55 are coded using 6 bits.

Assuming that the two selected uni-prediction motion vectors are Mv0 and Mv1. Two prediction blocks, P0 and P1, are obtained by performing motion compensation using Mv0 and Mv1, respectively. The final prediction block P is calculated as follows:

$$P = ( P 0 \times w 0 + P 1 \times ( 8 - w 0 ) ) >> 3$$

where the w0 is the weight matrix derived by the aforementioned weight prediction method.

After prediction, the uni-prediction motion vectors are stored in 4×4 granularity. For each 4×4 unit, one of two uni-prediction motion vector is stored.

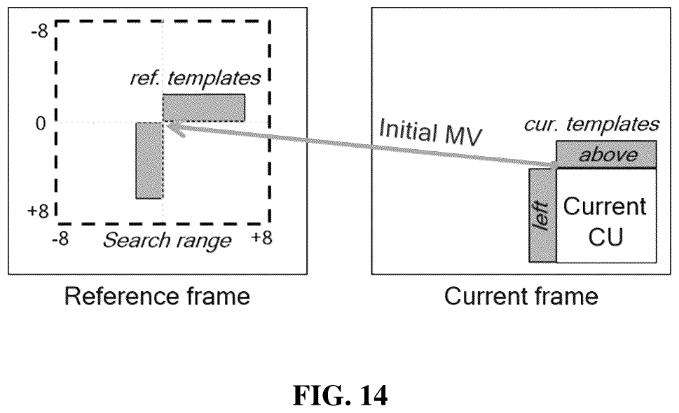

Template matching (TM) is further proposed. TM is a decoder-side MV derivation method to refine the motion information of the current CU by finding the closest match between a template (i.e., top and/or left neighbouring blocks of the current CU) in the current picture and a block (i.e., same size to the template) in a reference picture. FIG. 14 illustrates template matching performed on a search area around initial MV, according to some embodiments of the present disclosure. As illustrated in FIG. 14, a better MV is to be searched around the initial motion of the current CU within a [−8, +8]-pel search range. The TM mode can be applied to merge mode and AMVP mode.

When applying to merge mode, a merge candidate indicated by the signalled merge index is used as initial motion. The search method shown in Table 1 is performed to refine the motion.

TABLE 1
Search patterns of AMVR and merge mode with AMVR.

| | AMVR mode | | | | | |
|---|---|---|---|---|---|---|
| Search | 4- | Full- | Half- | Quarter- | Merge mode | |
| pattern | pel | pel | pel | pel | AltIF = 0 | AltIF = 1 |
| 4-pel | v | | | | | |
| diamond | | | | | | |
| 4-pel | v | | | | | |
| cross | | | | | | |
| Full-pel | | v | v | v | v | v |
| diamond | | | | | | |
| Full-pel | | v | v | v | v | v |
| cross | | | | | | |
| Half-pel | | | v | v | v | v |
| cross | | | | | | |
| Quarter-pel | | | | v | v | |
| cross | | | | | | |
| ⅛-pel | | | | | v | |
| cross | | | | | | |

TM may perform all the way down to ⅛-pel MVD precision or skipping those beyond half-pel MVD precision, depending on whether the alternative interpolation filter (that is used when AMVR is of half-pel mode) is used according to merged motion information.

In AMVP mode, an MVP candidate is determined based on template matching error to pick up the one which reaches the minimum difference between current block template and reference block template, and then TM performs only for this particular MVP candidate for MV refinement. TM refines this MVP candidate, starting from full-pel MVD precision (or 4-pel for 4-pel AMVR mode) within a [−8, +8]-pel search range by using iterative diamond search. The AMVP candidate may be further refined by using cross search with full-pel MVD precision (or 4-pel for 4-pel AMVR mode), followed sequentially by half-pel and quarter-pel ones depending on AMVR mode as specified in Table 1. This search process ensures that the MVP candidate still keeps the same MV precision as indicated by AMVR mode after TM process.

TM-based subblock motion refinement is further proposed. The template matching is proposed to apply to subblock based motion tools, including the affine and SbTMVP mode. More specifically, the control point motion vectors (CPMVs) of uni-predicted affine merge candidates and the motion shift of SbTMVP candidates are refined using TM. For a uni-predicted affine merge candidate, a same MV offset is assigned to all the CPMVs, and the TM cost of the affine candidate (e.g., including affine motion vector) is calculated accordingly. The optimal CPMV offset with the minimum TM cost can be used to refine the corresponding affine candidate. For a SbTMVP candidate, the initial motion shift can be refined with TM, and then the refined motion shift will be utilized to derive subblock temporal motion information.

The regression GPM implicitly derives the blending matrices with neighbor template (1 line above, 1 column left). However, it is only applied to regular motions but is not applied to affine motions. Therefore, regression GPM cannot benefit from the affine candidates that could provide a variety of rigid motion types in addition to translation.

The extension of affine motion compensation for GPM supports many other types of rigid motion. However, only uni-prediction candidates are applied in affine GPM. The uni-prediction candidate list is constructed in the same way as regular GPM. Therefore, Affine GPM cannot benefit from the more precise bi-directional affine motion compensation.

Embodiments of the present disclosure provide methods of applying affine motion compensation (AMC) for regression GPM.

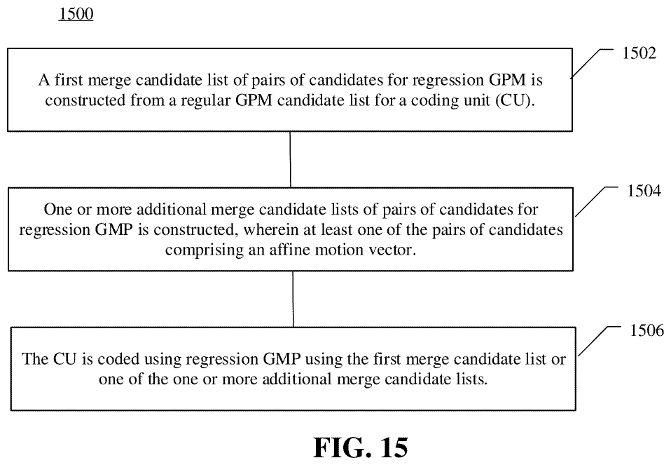

FIG. 15 illustrates an example flow chart of a method 1500 of affine extension for regression GPM, according to some embodiments of the present disclosure. Method 1500 can be performed by an encoder (e.g., by process 200A of FIG. 2A or 200B of FIG. 2B), a decoder (e.g., by process 300A of FIG. 3A or 300B of FIG. 3B) or performed by one or more software or hardware components of an apparatus (e.g., apparatus 400 of FIG. 4). For example, a processor (e.g., processor 402 of FIG. 4) can perform method 1500. In some embodiments, method 1500 can be implemented by a computer program product, embodied in a computer-readable medium, including computer-executable instructions, such as program code, executed by computers (e.g., apparatus 400 of FIG. 4). Referring to FIG. 15, method 1500 may include the following steps 1502-1506.

At step 1502, a first merge candidate list of pairs of candidates for regression GPM is constructed from a regular GPM candidate list for a coding unit (CU). A merge candidate list of pairs of candidates can be illustrated as {(A1, A2), (B1, B2), (C1, C2)}, where A1, A2, B1, B2, C1, C2 are motion vectors. In this example, the merge candidate list includes three pairs of candidates. It can be understood that the number of pairs of candidates can vary. One pair of candidates includes a first motion vector (e.g., A1, B2, C1) and a second motion vector (e.g., A2, B2, C2). The first motion vector in a pair of candidates is used for a first partition and the second motion vector in the pair of candidates is used for a second partition. In the first merge candidate list, two motion vectors (e.g., (A1, A2), (B1, B2), (C1, C2)) of one pair of candidates in the first merge candidate list are regular motion vectors, e.g., these motion vectors are derived from regular merge mode. Blending matrices can be derived during the list construction. One pair of candidates corresponds to one derived blending matrices. The pairs of candidates in the first merge candidate list are recorded with template costs. The template costs are calculated based on the derived blending matrices and the prediction of the pair of motion vectors.

At step 1504, one or more additional merge candidate lists of pairs of candidates for regression GPM is constructed, wherein at least one of the pairs of candidates comprising an affine motion vector. Blending matrices can be derived during the list construction. One pair of candidates corresponds to one derived blending matrices. The pairs of candidates in the one or more merge candidate lists are recorded with template costs. The template costs are calculated based on the derived blending matrices and the prediction of the pair of motion vectors.

At step 1506, the CU is coded using regression GPM using the first merge candidate list or one of the one or more additional merge candidate lists. Based on the regression GPM, the pair of candidates used for encoding is selected from the first merge candidate list or one of the one or more additional merge candidate lists, for example, a merge-idx is signaled to indicate the pair of candidates to be used. Then, the CU is divided into a first partition and a second partition based on blending matrices corresponding to the pair of candidates to be used, and coded using the indicated pair of candidates.

In some embodiments, a second merge candidate list of pairs of candidates is constructed from the affine GPM candidate list, and the pairs of candidates in the second merge candidate list are recorded with template costs. That is, both motion vectors (e.g., (A1, A2), (B1, B2), (C1, C2)) of one pair of candidates in the second merge candidate list are from the affine GPM candidate list, i.e., affine motion vectors. Then, a parameter (e.g., a flag) indicating whether the second merge candidate list is used is signaled. In response to the flag being a first value (for example, true or “1”) indicating the second merge candidate list is used, both the first partition and the second partition of the CU are coded using the second merge candidate list.

In some embodiments, a third merge candidate list and a fourth merge candidate list of pairs of candidates are constructed by hybridizing regular GPM candidates and affine GPM candidates. In the third merge candidate list, all the first motion vectors (e.g., A1, B1, C1) of one pair of candidates are selected from regular GPM candidates, and all the second motion vectors (e.g., A2, B2, C2) of one pair of candidates are selected from affine GPM candidates. In the fourth merge candidate list, all the first motion vectors (e.g., A1, B1, C1) of one pair of candidates are selected from affine GPM candidates, and all the second motion vectors (e.g., A2, B2, C2) of one pair of candidates are selected from regular GPM candidates. Therefore, in this example, there are four merge candidate lists constructed.

Then, two parameters are signaled. For example, a first parameter (e.g. a first flag) indicates whether affine motion compensation (AMC) is enabled for the first partition and the second parameter (e.g. a second flag) indicates whether the AMC is enabled for the second partition. One example is shown in Table 2:

TABLE 2
Example of applying affine motion
compensation to regression GPM

| the 1^{st} | the 2^{nd} | |
|---|---|---|
| parameter | parameter | |
| 0 | 0 | none of partitions use affine motion compensation |
| 0 | 1 | only the 2^{nd} partition use affine motion |
| | | compensation |
| 1 | 0 | only the 1^{st} partition use affine motion |
| | | compensation |
| 1 | 1 | both partitions use affine motion compensation |

Referring to Table 2, in this example, when both the first flag and second flag indicate the AMC being not enabled, then, the CU is coded using the first merge 1 candidate list. When the first flag indicates the AMC being not enabled for the first partition while the second flag indicates the AMC being enabled for the second partition, then, the CU is coded using the third merge candidate list. When the first flag indicates the AMC being enabled for the first partition while the second flag indicates the candidate being not enabled for the second partition, then the CU is coded using the fourth merge candidate list. When both the first flag and second indicate the AMC being enabled, then the CU is coded using the second merge candidate list.

In some embodiments, the second merge candidate list having both motion vectors (e.g., (A1, A2), (B1, B2), (C1, C2)) of one pair of candidates from the affine GPM candidate list is discarded. That is, there are three merge candidate lists (i.e., the first merge candidate list, the third merge candidate list, and the fourth merge candidate list) in this example. Then, a parameter (e.g. a first flag) is signaled to indicate whether the AMC is enabled for any of the two partitions, i.e., whether the merge candidate list including affine GPM candidate is used. If the first flag being a first value (e.g., true or “1”), a second parameter (e.g. a second flag) is signaled to indicate whether the AMC is enabled for the first partition. One example is shown in Table 3:

TABLE 1
Example of applying affine motion
compensation to regression GPM

| the 1^{st} | the 2^{nd} | |
|---|---|---|
| parameter | parameter | |
| 0 | | none of partitions use affine motion |
| | | compensation |
| 1 | 0 | only the 2^{nd} partition use affine motion |
| | | compensation |
| 1 | 1 | only the 1^{st} partition use affine motion |
| | | compensation |

Referring to Table 3, in this example, the first flag is signaled first, when the first flag is a second value (e.g., false or “0”) indicating the AMC is not enabled for the first partition nor the second partition, then the CU is coded using the first merge candidate list. When the first flag is a first value (e.g., true or “1”) indicating the AMC is enabled, then the second flag is signaled. When the second flag is a second value (e.g., false or “0”) indicating the AMC is enabled only for the second partition, then the CU is coded using the third merge candidate list. When the second flag being a first value (e.g., true or “1”) indicating the AMC is enabled only for the first partition, then the coding unit is coded using the fourth merge candidate list.

In some embodiments, only one merge candidate list is constructed. The first merge candidate list, the second merge candidate list, the third merge candidate list, and the fourth merge candidate list are merged into one merge candidate list. Therefore, the pairs of candidates in the merge candidate list include three types of candidates (e.g., regular motions for both partitions, affine motions for both partitions and regular or affine motions for each partition individually). The pairs of candidates is further reordered with the template costs.

In some embodiments, the affine extension of regression GPM is enabled only for large blocks. An area of the coding unit is determined whether being greater than a threshold, for example, 512 pixels. When the area is greater than the threshold, the merge candidate lists of pairs of candidates for the two partitions can be selected, for example, referring to Table 2 or Table 3, by signaling one or more flags. When the area of the coding unit is smaller than or equal to the threshold, only the first merge candidate list is used.

In some embodiments, the affine extension of regression GPM is only enabled for frames in top temporal layers (TLayers, TL). One sequence may include multiple temporal layers. A frame belongs to one temporal layer, and an index of the temporal layer (i.e., temporal id) is used to indicate an index of the temporal layer of the current frame. Whether the affine extension of regression GPM is enabled or not for current frame is determined based on the index of the temporal layer. In some embodiments, the affine extension of regression GPM is enabled only for the frames with the index of Tlayer greater than a preset value. For example, for one sequence having 6 temporal layers, when the index of Tlayer (e.g., temporal_id) of the current frame is larger than 2, e.g., the TL of the current frame is TL3, TL4, or TL5, the merge candidate lists of pairs of candidates for the two partitions can be selected, for example, referring to Table 2 or Table 3, by signaling one or more flags. When the index of Tlayer of the current frame is smaller than or equal to 2, for example, the TL of the current frame is TL1, TL1 and TL2, then only the first merge candidate list is used for both partitions.

In some embodiments, TM (Template Matching) is applied to refine CPMVs for affine GPM candidates in the merge candidate list for regression GPM. Whether to refine CPMVs of an affine motion vector using TM is determined based on a threshold of template cost. For example, a first template cost of the original CPMVs is calculated and a second template cost of the TM refined CPMVs is calculated. Then, the second template cost is compared with the first template cost. If a ratio of the second template cost with the first template cost is smaller than a threshold, the CPMVs are refined using the TM, that is, the original CPMVs of the affine vector is replaced by the TM refined CPMVs. If the ratio of the second template cost with the first template cost is greater than or equal to the threshold, the original CPMVs are used, that is, the TM refinement is not performed on the CPMVs. For example, the threshold could be 0.5, 0.3, etc. In some embodiments, the pairs of candidates are reordered based on the template cost. In some embodiments, the CPMVs are refined during the list construction before the pairs of candidates in the merge candidate list recorded. In some embodiments, the CPMVs are refined after the pairs of candidates in the merge candidate list reordered.

The proposed methods of applying the AMC to regression GPM can also be applied to AWP mode in AVS3 standard. The details of the method may be found by referring to those described above, which will not be repeated here.

Embodiments of the present disclosure provide a method for extending bi-predictive motion vectors to Affine GPM.

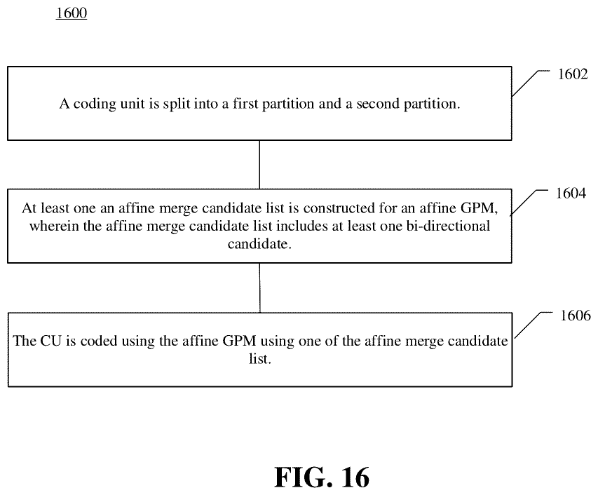

FIG. 16 illustrates an example flow chart of a method 1600 for extending bi-predictive motion vectors to affine GPM, according to some embodiments of the present disclosure. Method 1600 can be performed by an encoder (e.g., by process 200A of FIG. 2A or 200B of FIG. 2B), a decoder (e.g., by process 300A of FIG. 3A or 300B of FIG. 3B) or performed by one or more software or hardware components of an apparatus (e.g., apparatus 400 of FIG. 4). For example, a processor (e.g., processor 402 of FIG. 4) can perform method 1600. In some embodiments, method 1600 can be implemented by a computer program product, embodied in a computer-readable medium, including computer-executable instructions, such as program code, executed by computers (e.g., apparatus 400 of FIG. 4). Referring to FIG. 16, method 1600 may include the following steps 1602-1606.

At step 1602, a coding unit is split into a first partition and a second partition.

At step 1604, at least one affine merge candidate list is constructed for an affine GPM, wherein the affine merge candidate list includes at least one bi-directional candidate. The bi-directional candidate can be a bi-predictive motion vector.

In some embodiments, when constructing the affine merge candidate list for GPM, the initial affine merge candidate list that may contain bi-directional candidates is directly used as the final affine merge candidate list for GPM. That is, an extraction process that extracts uni-directional candidates using parity is discarded.

At step 1606, the CU is coded using the affine GPM using one of the affine merge candidate lists.

In some embodiments, when constructing the affine merge candidate list for GPM, two separate candidate lists are generated simultaneously. For example, an initial affine merge candidate list for a regular merge mode is constructed, the initial affine merge candidate list includes uni-directional candidates and bi-directional candidates. Then, a uni-prediction affine merge candidate list that includes only uni-directional candidates is constructed by extracting uni-directional candidates using parity from the initial affine merge candidate list; and a bi-prediction affine merge candidate list that includes only bi-directional candidates is constructed by removing the uni-directional candidates from the initial affine merge candidate list. In some embodiments, the two affine merge candidate lists are reordered by ARMC (Adaptive reordering of merge candidates with template matching) respectively, and the best ten candidates based on template cost are selected in priority for each affine merge candidate list. For example, only the top ten candidates are selected for each affine merge candidate list.

In some embodiments, when a coding unit is coded in GPM mode, which affine merge candidate list is used for the current coding block is determined based on motion vectors used for neighbor positions. Whether bi-direction motion vectors are used for a plurality of neighbor positions of the CU are determined. Then a number of the neighbor positions where the bi-directional motion vectors used is counted. If the number the neighbor positions where the bi-directional motion vector used is greater or equal to a threshold, the CU is coded using the bi-directional merge candidate list. If the number of the neighbor positions where the bi-directional motion vector used is less than the threshold, the CU is coded using the uni-directional merge candidate list. For example, a total of twelve neighbor positions are detected (e.g., Left, Left bottom, Top, Top right, Top left and seven positions of one pixel from the left or upper boundaries of the current block). When there are greater than or equal to nine of twelve positions utilizing Bi-directional motion vectors, the bi-prediction affine merge candidate list is selected for the current coding unit. When there are less than nine of twelve positions utilizing bi-directional motion vectors, the uni-prediction affine merge candidate list is selected for the current coding unit. In some embodiments, a parameter (e.g., a flag) is derived from the motion vectors used for neighbor positions. For example, when there are greater than or equal to nine of twelve positions utilizing bi-directional motion vectors, a value of the flag is derived to be a first value indicating that the bi-prediction affine merge candidate list is selected for the current coding unit. When there are less than nine of twelve positions utilizing Bi-directional motion vectors, a value of the flag is derived to be a first value indicating the Uni-prediction affine merge candidate list is selected for the current coding unit.

In some embodiments, when a coding unit is coded in GPM mode, a parameter (e.g. a flag) is signaled to indicate which affine merge candidate list to be selected. For example, when the flag has a first value indicating the uni-directional affine merge candidate list to be used, the CU is then coded using the uni-directional affine merge candidate list. When the flag has a second value indicating the bi-directional affine merge candidate list to be used, the CU is then coded using the bi-directional affine merge candidate list. In some embodiments, the selected affine merge candidate list is used for both partitions. That is, both the two partitions use the same affine merge candidate list.

In some embodiments, to allow for more flexibility, each partition can individually select bi-directional affine merge candidate list or uni-directional affine merge candidate list. When a coding unit is coded in GPM mode, besides two original flags (e.g., gpm_affine_flag) indicating whether Affine GPM is applied for each partition, two additional flags are signaled to indicate whether bi-directional affine motion vectors are used. For example, a first parameter (e.g. a first flag) is signaled to indicate whether the first partition uses bi-directional motion vectors and a second parameter (e.g. a second flag) is signaled to indicate whether the second partition uses bi-directional motion vectors. One example is shown in Table 4:

TABLE 4
Example of applying Bi-directional
affine motion compensation to GPM

| the 1^{st} | the 2^{nd} | |
|---|---|---|
| parameter | parameter | |
| 0 | 0 | none of partitions use Bi-directional affine |
| | | motion compensation |
| 0 | 1 | only the 2^{nd} partition use Bi-directional affine |
| | | motion compensation |
| 1 | 0 | only the 1^{st} partition use aBi-directional affine |
| | | motion compensation |
| 1 | 1 | both partitions use Bi-directional affine |
| | | motion compensation |

Referring to Table 4, in this example, when both the first flag and second flag indicate the bi-directional affine motion compensation (AMC) being not enabled, then both partitions are coded using the uni-prediction affine merge candidate list. When the first flag indicates the bi-directional AMC being not enabled for the first partition while the second flag indicates the bi-direction AMC being enabled for the second partition, then the first partition is coded using the uni-prediction affine merge candidate list and the second partition is coded using the bi-prediction affine merge candidate list. When the first flag indicates the bi-direction AMC being enabled for the first partition while the second flag indicates the bi-direction AMC being not enabled for the second partition, then the first partition is coded using the bi-dictional affine merge candidate list and the second partition is coded using the uni-dictional affine merge candidate list. When both the first flag and second flag indicate the bi-directional AMC being enabled, then both the first partition and the second partition are coded using the bi-prediction affine merge candidate list.

It is noted that the proposed methods of applying bi-directional affine motion compensation to GPM can also be applied to AWP mode in AVS3 standard.

The embodiments described in the present disclosure can be freely combined.

In some embodiments, a non-transitory computer readable medium storing a bitstream is provided. The bitstream is generated by receiving a video sequence and encoding the video sequence to generate coded information included in the bitstream. The bitstream can be transmitted to a decoder for decoding. The video sequence is encoded by the above-described methods.

In some embodiments, a non-transitory computer-readable storage medium including instructions is also provided, and the instructions may be executed by a device (such as the disclosed encoder and decoder), for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above-described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above-described modules/units may be combined as one module/unit, and each of the above-described modules/units may be further divided into a plurality of sub-modules/sub-units.

The embodiments may further be described using the following clauses:
1. A method of encoding a video sequence, the method comprising:
receiving a video sequence;
encoding the video sequence by:
   constructing a first merge candidate list of pairs of candidates from a regular geometric partition mode (GPM) candidate list for a code unit (CU);
   constructing one or more additional merge candidate lists of pairs of candidates, wherein each pair of candidates comprises a first motion vector for a first partition and a second motion vector for a second partition, at least one of the pairs of candidates in the one or more additional merge candidate lists comprises an affine motion vector; and
   encoding the CU using a regression GPM using the first merge candidate list or one of the one or more additional merge candidate lists, wherein the CU comprises a first partition and a second partition.
2. The method according to clause 1, wherein constructing the one or more additional merge candidate lists of pairs of candidates further comprises:
   constructing a second merge candidate list of pairs of candidates from an affine GPM candidate list.
3. The method according to clause 2, wherein after constructing the second merge candidate list of pairs of candidates from the affine GPM candidate list, the method further comprises:
   reordering the pairs of candidates in the second merge candidate list with template costs.
4. The method according to clause 2, wherein encoding the CU using the first merge candidate list or one of the one or more additional merge candidate lists further comprises:
   encoding a flag indicating whether affine motion compensation (AMC) is enabled for the CU; and
   in response to the flag indicating the AMC being enabled for the CU, encoding the CU using the second merge candidate list.
5. The method according to clause 2, wherein constructing the one or more additional merge candidate lists of pairs of candidates for regression GPM further comprises:
   constructing a third merge candidate list of pairs of candidates, wherein a first motion vector in a pair of candidates is selected from regular GPM candidates, and a second motion vector in the pair of candidates is selected from affine GPM candidates; and
   constructing a fourth merge candidate list of pairs of candidates, wherein a first motion vector in a pair of candidates is selected from affine GPM candidates, and a second motion vector in the pair of candidates is selected from regular GPM candidates.
6. The method according to clause 5, wherein encoding the CU using the first merge candidate list or one of the one or more additional merge candidate lists further comprises:
   encoding a first flag indicating whether affine motion compensation (AMC) is enabled for the first partition and a second flag indicating the AMC is enabled for the second partition;
   in response to the first flag and the second flag indicating the AMC is enabled for none of the first partition and the second partition, encoding the CU using the first merge candidate list;
   in response to the first flag indicating the AMC being not enabled for the first partition, and the second flag indicating the AMC being enabled for the second partition, encoding the CU using the third merge candidate list;
   in response to the first flag indicating the AMC being enabled for the first partition, and the second flag indicating the AMC being not enabled for the second partition, encoding the CU using the fourth merge candidate list; and
   in response to the first flag and the second flag indicating the AMC being enabled for both the first partition and the second partition, encoding the CU using the second merge candidate list.
7. The method according to clause 5, wherein encoding the CU using the first merge candidate list or one of the one or more additional merge candidate lists further comprises:
   encoding a first flag indicating whether affine motion compensation (AMC) is enabled for the CU;
   in response to the first flag indicating the AMC is enabled for the CU, encoding a second flag indicating whether the AMC is enabled for the first partition;
   in response to the second flag indicating the AMC being not enabled for the first partition, encoding the CU using the third merge candidate list;
   in response to the second flag indicating the AMC being enabled for the first partition, encoding the CU using the fourth merge candidate list.
8. The method according to clause 5, further comprising:
   merging the first merge candidate list, the second merge candidate list, the third merge candidate list, and the fourth merge candidate list into a fifth merge candidate list;
   reordering pairs of candidates in the fifth merge candidate list with template cost values; and
   encoding the CU using the fifth merge candidate list.
9. The method according to clause 1, wherein encoding the CU using the first merge candidate list or one of the one or more additional merge candidate lists further comprises:
   determining an area of the CU;
   in response to the area of the CU being smaller than or equal to a threshold, encoding the CU using the first merge candidate list; and
   in response to the area of the CU being greater than the threshold, encoding the CU using the first merge candidate list or one of the one or more additional merge candidate lists.
10. The method according to clause 1, wherein encoding the CU using the first merge candidate list or one of the one or more additional merge candidate lists further comprises:
   determining a temporal layer (TL) of a current frame;
   in response to an index of the TL of the current frame being smaller than or equal to a threshold, encoding the CU using the first merge candidate list; and
   in response to the index of then TL of the current frame being greater than the threshold, encoding the CU using the first merge candidate list or one of the one or more additional merge candidate lists.
11. The method according to clause 1, wherein constructing the one or more additional merge candidate lists of pairs of candidates further comprises:
   calculating a first template cost of original CPMVs of the affine motion vector and a second template cost of template matching (TM) refined CPMVs of the affine motion vector;
   comparing the first template cost and the second template cost; and
   in response to a ratio of the second template cost with the first template cost is smaller than a threshold, replacing the original CPMVs with the TM-refined CPMVs.
12. The method according to clause 11, further comprising:
   reordering the pairs of candidates in an additional merge candidate list based on template costs.
13. The method according to clause 11, wherein before the calculation, the method further comprises:
   reordering the pairs of candidates in an additional merge candidate list based on template costs.
14. A method for decoding a bitstream, the method comprising:
receiving a bitstream; and
decoding the bitstream to generate a video sequence, the decoding comprising:
   constructing a first merge candidate list of pairs of candidates from a regular geometric partition mode (GPM) candidate list for a code unit (CU);
   constructing one or more additional merge candidate lists of pairs of candidates, wherein each pair of candidates comprises a first motion vector for a first partition and a second motion vector for a second partition, at least one of the pairs of candidates in the one or more additional merge candidate lists comprises an affine motion vector; and
   decoding the CU using a regression GPM using the first merge candidate list or one of the one or more additional merge candidate lists, wherein the CU comprises a first partition and a second partition.
15. The method according to clause 14, wherein constructing the one or more additional merge candidate lists of pairs of candidates further comprises:
   constructing a second merge candidate list of pairs of candidates from an affine GPM candidate list.
16. The method according to clause 15, wherein after constructing the second merge candidate list of pairs of candidates from the affine GPM candidate list, the method further comprises:
   reordering the pairs of candidates in the second merge candidate list with template costs.
17. The method according to clause 15, wherein encoding the CU using the first merge candidate list or one of the one or more additional merge candidate lists further comprises:
   decoding a flag indicating whether affine motion compensation (AMC) is enabled for the CU; and
   in response to the flag indicating the AMC being enabled for the CU, decoding the CU using the second merge candidate list.
18. The method according to clause 15, wherein constructing the one or more additional merge candidate lists of pairs of candidates for regression GPM further comprises:
   constructing a third merge candidate list of pairs of candidates, wherein a first motion vector in a pair of candidates is selected from regular GPM candidates, and a second motion vector in the pair of candidates is selected from affine GPM candidates; and
   constructing a fourth merge candidate list of pairs of candidates, wherein a first motion vector in a pair of candidates is selected from affine GPM candidates, and a second motion vector in the pair of candidates is selected from regular GPM candidates.
19. The method according to clause 18, wherein encoding the CU using the first merge candidate list or one of the one or more additional merge candidate lists further comprises:
   decoding a first flag indicating whether affine motion compensation (AMC) is enabled for the first partition and a second flag indicating the AMC is enabled for the second partition;
   in response to the first flag and the second flag indicating the AMC is enabled for none of the first partition and the second partition, decoding the CU using the first merge candidate list;
   in response to the first flag indicating the AMC being not enabled for the first partition, and the second flag indicating the AMC being enabled for the second partition, decoding the CU using the third merge candidate list;
   in response to the first flag indicating the AMC being enabled for the first partition, and the second flag indicating the AMC being not enabled for the second partition, decoding the CU using the fourth merge candidate list; and
   in response to the first flag and the second flag indicating the AMC being enabled for both the first partition and the second partition, decoding the CU using the second merge candidate list.
20. The method according to clause 18, wherein encoding the CU using the first merge candidate list or one of the one or more additional merge candidate lists further comprises:
   decoding a first flag indicating whether affine motion compensation (AMC) is enabled for the CU;
   in response to the first flag indicating the AMC is enabled for the CU, decoding a second flag indicating whether the AMC is enabled for the first partition;
   in response to the second flag indicating the AMC being not enabled for the first partition, decoding the CU using the third merge candidate list;
   in response to the second flag indicating the AMC being enabled for the first partition, decoding the CU using the fourth merge candidate list.
21. The method according to clause 18, further comprising:
   merging the first merge candidate list, the second merge candidate list, the third merge candidate list, and the fourth merge candidate list into a fifth merge candidate list;
   reordering pairs of candidates in the fifth merge candidate list with template cost values; and
   decoding the CU using the fifth merge candidate list.
22. The method according to clause 14, wherein encoding the CU using the first merge candidate list or one of the one or more additional merge candidate lists further comprises:
   determining an area of the CU;
   in response to the area of the CU being smaller than or equal to a threshold, decoding the CU using the first merge candidate list; and
   in response to the area of the CU being greater than the threshold, decoding the CU using the first merge candidate list or one of the one or more additional merge candidate lists.
23. The method according to clause 14, wherein decoding the CU using the first merge candidate list or one of the one or more additional merge candidate lists further comprises:
   determining a temporal layer (TL) of a current frame;
   in response to an index of the TL of the current frame being smaller than or equal to a threshold, decoding the CU using the first merge candidate list; and
   in response to the index of then TL of the current frame being greater than the threshold, decoding the CU using the first merge candidate list or one of the one or more additional merge candidate lists.
24. The method according to clause 14, wherein constructing the one or more additional merge candidate lists of pairs of candidates further comprises:
   calculating a first template cost of original CPMVs of the affine motion vector and a second template cost of template matching (TM) refined CPMVs of the affine motion vector;
   comparing the first template cost and the second template cost; and
   in response to a ratio of the second template cost with the first template cost is smaller than a threshold, replacing the original CPMVs with the TM-refined CPMVs.
25. The method according to clause 24, further comprising:
   reordering the pairs of candidates in an additional merge candidate list based on template costs.
26. The method according to clause 14, wherein before the calculation, the method further comprises:
   reordering the pairs of candidates in an additional merge candidate list based on template costs.
27. A method for signaling a bitstream, the method comprising:
   receiving a video sequence;
   encoding the video sequence by:
      constructing a first merge candidate list of pairs of candidates from a regular geometric partition mode (GPM) candidate list for a code unit (CU);
      constructing one or more additional merge candidate lists of pairs of candidates, wherein each pair of candidates comprises a first motion vector for a first partition and a second motion vector for a second partition, at least one of the pairs of candidates in the one or more additional merge candidate lists comprises an affine motion vector; and
      encoding the CU using a regression GPM using the first merge candidate list or one of the one or more additional merge candidate lists, wherein the CU comprises a first partition and a second partition; and
      signaling a bitstream that is generated based on the encoding
28. The method according to clause 27, wherein constructing the one or more additional merge candidate lists of pairs of candidates further comprises:
   constructing a second merge candidate list of pairs of candidates from an affine GPM candidate list.
29. The method according to clause 28, wherein after constructing the second merge candidate list of pairs of candidates from the affine GPM candidate list, the method further comprises:
   reordering the pairs of candidates in the second merge candidate list with template costs.
30. The method according to clause 28, wherein encoding the CU using the first merge candidate list or one of the one or more additional merge candidate lists further comprises:
   encoding a flag indicating whether affine motion compensation (AMC) is enabled for the CU; and
   in response to the flag indicating the AMC being enabled for the CU, encoding the CU using the second merge candidate list.
31. The method according to clause 28, wherein constructing the one or more additional merge candidate lists of pairs of candidates for regression GPM further comprises:
   constructing a third merge candidate list of pairs of candidates, wherein a first motion vector in a pair of candidates is selected from regular GPM candidates, and a second motion vector in the pair of candidates is selected from affine GPM candidates; and
   constructing a fourth merge candidate list of pairs of candidates, wherein a first motion vector in a pair of candidates is selected from affine GPM candidates, and a second motion vector in the pair of candidates is selected from regular GPM candidates.
32. The method according to clause 31, wherein encoding the CU using the first merge candidate list or one of the one or more additional merge candidate lists further comprises:
   encoding a first flag indicating whether affine motion compensation (AMC) is enabled for the first partition and a second flag indicating the AMC is enabled for the second partition;
   in response to the first flag and the second flag indicating the AMC is enabled for none of the first partition and the second partition, encoding the CU using the first merge candidate list;
   in response to the first flag indicating the AMC being not enabled for the first partition, and the second flag indicating the AMC being enabled for the second partition, encoding the CU using the third merge candidate list;
   in response to the first flag indicating the AMC being enabled for the first partition, and the second flag indicating the AMC being not enabled for the second partition, encoding the CU using the fourth merge candidate list; and
   in response to the first flag and the second flag indicating the AMC being enabled for both the first partition and the second partition, encoding the CU using the second merge candidate list.
33. The method according to clause 31, wherein encoding the CU using the first merge candidate list or one of the one or more additional merge candidate lists further comprises:
   encoding a first flag indicating whether affine motion compensation (AMC) is enabled for the CU;
   in response to the first flag indicating the AMC is enabled for the CU, encoding a second flag indicating whether the AMC is enabled for the first partition;
   in response to the second flag indicating the AMC being not enabled for the first partition, encoding the CU using the third merge candidate list;
   in response to the second flag indicating the AMC being enabled for the first partition, encoding the CU using the fourth merge candidate list.
34. The method according to clause 31, further comprising:
   merging the first merge candidate list, the second merge candidate list, the third merge candidate list, and the fourth merge candidate list into a fifth merge candidate list;
   reordering pairs of candidates in the fifth merge candidate list with template cost values; and
   encoding the CU using the fifth merge candidate list.
35. The method according to clause 27, wherein encoding the CU using the first merge candidate list or one of the one or more additional merge candidate lists further comprises:
   determining an area of the CU;
   in response to the area of the CU being smaller than or equal to a threshold, encoding the CU using the first merge candidate list; and
   in response to the area of the CU being greater than the threshold, encoding the CU using the first merge candidate list or one of the one or more additional merge candidate lists.
36. The method according to clause 27, wherein encoding the CU using the first merge candidate list or one of the one or more additional merge candidate lists further comprises:
   determining a temporal layer (TL) of a current frame;
   in response to an index of the TL of the current frame being smaller than or equal to a threshold, encoding the CU using the first merge candidate list; and
   in response to the index of then TL of the current frame being greater than the threshold, encoding the CU using the first merge candidate list or one of the one or more additional merge candidate lists.
37. The method according to clause 27, wherein constructing the one or more additional merge candidate lists of pairs of candidates further comprises:
   calculating a first template cost of original CPMVs of the affine motion vector and a second template cost of template matching (TM) refined CPMVs of the affine motion vector;
   comparing the first template cost and the second template cost; and
   in response to a ratio of the second template cost with the first template cost is smaller than a threshold, replacing the original CPMVs with the TM-refined CPMVs.
38. The method according to clause 37, further comprising:
   reordering the pairs of candidates in an additional merge candidate list based on template costs.
39. The method according to clause 37, wherein before the calculation, the method further comprises:
   reordering the pairs of candidates in an additional merge candidate list based on template costs.
40. A method of encoding a video sequence, the method comprising:
receiving a video sequence;
encoding the video sequence by:
   dividing a coding unit (CU) into a first partition and a second partition;
   constructing at least one affine merge candidate list, wherein one of the at least one affine merge candidate list comprises bi-directional candidates; and
   encoding the CU using an affine geometric partition mode (GPM) using one of the at least one affine merge candidate list.
41. The method according to clause 40, wherein constructing the at least one affine merge candidate list further comprises:
   constructing an initial affine merge candidate list for a regular merge mode; and
   encoding the CU using the affine GPM using the initial affine merge candidate list.
42. The method according to clause 40, wherein constructing the at least one affine merge candidate list further comprises:
   constructing an initial affine merge candidate list for a regular merge mode;
   extracting uni-directional candidates from the initial affine merge candidate list to obtain a uni-directional affine merge candidate list; and
   extracting bi-directional candidates from the initial affine merge candidate list to obtain a bi-directional affine merge candidate list; and
encoding the CU using the affine GPM using one of the at least one affine merge candidate list further comprising:
   encoding the CU using affine GPM using the uni-directional affine merge candidate list or the bi-directional merge candidate list.
43. The method according to clause 42, wherein encoding the CU using affine GPM using the uni-directional affine merge candidate list or the bi-directional merge candidate list further comprises:
   determining whether bi-directional motion vectors used for a plurality of neighbor positions of the CU;
   counting a number of the neighbor positions where the bi-directional motion vectors used;
   in response the number of the neighbor positions where the bi-directional motion vectors used being greater than or equal to a threshold, encoding the CU using the bi-directional merge candidate list.
44. The method according to clause 42, wherein encoding the CU using affine GPM using the uni-directional affine merge candidate list or the bi-directional merge candidate list further comprises:
   encoding a flag indicating which merge candidate list to be used;
   in response to the flag indicating the uni-directional merge candidate list to be used, encoding the CU using the uni-directional merge candidate list; and
   in response to the flag indicating the bi-directional merge candidate list to be used, encoding the CU using the bi-directional merge candidate list.
45. The method according to clause 42, wherein encoding the CU using affine GPM using the uni-directional affine merge candidate list or the bi-directional merge candidate list further comprises:
   encoding a first flag indicating whether bi-directional affine motion compensation is enabled for the first partition and a second flag indicating bi-directional affine motion compensation is enabled for the second partition;
   in response to the first flag and the second flag indicating the bi-directional affine motion compensation is enabled for none of the first partition and the second partition, encoding the both the first partition and the second partition using the uni-directional affine merge candidate list;
   in response to the first flag indicating the bi-directional affine motion compensation being not enabled for the first partition, and the second flag indicating the bi-directional affine motion compensation being enabled for the second partition, encoding the first partition using the uni-directional affine merge candidate list and encoding the second partition using the bi-directional affine merge candidate list;
   in response to the first flag indicating the bi-directional affine motion compensation being enabled for the first partition, and the second flag indicating the bi-directional affine motion compensation being not enabled for the second partition, encoding the first partition using the bi-directional affine merge candidate list and encoding the second partition using the uni-directional affine merge candidate list; and
   in response to the first flag and the second flag indicating the bi-directional affine motion compensation being enabled for both the first partition and the second partition, encoding both the first partition and the second partition using the bi-directional affine merge candidate list.
46. The method according to clause 42, further comprising:
   reordering candidates in the uni-directional affine merge candidate list and bi-directional affine merge candidate list by adaptive reordering of merge candidates with template matching (ARMC), respectively.
47. A method for decoding a bitstream, the method comprising:
receiving a bitstream; and
decoding the bitstream to generate a video sequence, the decoding comprising:
   dividing a coding unit (CU) into a first partition and a second partition;
   constructing at least one affine merge candidate list, wherein one of the at least one affine merge candidate list comprises bi-directional candidates; and
   decoding the CU using an affine geometric partition mode (GPM) using one of the at least one affine merge candidate list.
48. The method according to clause 47, wherein constructing the at least one affine merge candidate list further comprises:
   constructing an initial affine merge candidate list for a regular merge mode; and
   decoding the CU using the affine GPM using the initial affine merge candidate list.
49. The method according to clause 47, wherein constructing the at least one affine merge candidate list further comprises:
   constructing an initial affine merge candidate list for a regular merge mode;
   extracting uni-directional candidates from the initial affine merge candidate list to obtain a uni-directional affine merge candidate list; and
   extracting bi-directional candidates from the initial affine merge candidate list to obtain a bi-directional affine merge candidate list; and
decoding the CU using the affine GPM using one of the at least one affine merge candidate list further comprising:
   decoding the CU using affine GPM using the uni-directional affine merge candidate list or the bi-directional merge candidate list.
50. The method according to clause 49, wherein encoding the CU using affine GPM using the uni-directional affine merge candidate list or the bi-directional merge candidate list further comprises:
   determining whether bi-directional motion vectors used for a plurality of neighbor positions of the CU;
   counting a number of the neighbor positions where the bi-directional motion vectors used;
   in response the number of the neighbor positions where the bi-directional motion vectors used being greater than or equal to a threshold, decoding the CU using the bi-directional merge candidate list.
51. The method according to clause 49, wherein encoding the CU using affine GPM using the uni-directional affine merge candidate list or the bi-directional merge candidate list further comprises:
   decoding a flag indicating which merge candidate list to be used;
   in response to the flag indicating the uni-directional merge candidate list to be used, decoding the CU using the uni-directional merge candidate list; and
   in response to the flag indicating the bi-directional merge candidate list to be used, decoding the CU using the bi-directional merge candidate list.
52. The method according to clause 49, wherein encoding the CU using affine GPM using the uni-directional affine merge candidate list or the bi-directional merge candidate list further comprises:
   decoding a first flag indicating whether bi-directional affine motion compensation is enabled for the first partition and a second flag indicating bi-directional affine motion compensation is enabled for the second partition;
   in response to the first flag and the second flag indicating the bi-directional affine motion compensation is enabled for none of the first partition and the second partition, decoding the both the first partition and the second partition using the uni-directional affine merge candidate list;
   in response to the first flag indicating the bi-directional affine motion compensation being not enabled for the first partition, and the second flag indicating the bi-directional affine motion compensation being enabled for the second partition, decoding the first partition using the uni-directional affine merge candidate list and encoding the second partition using the bi-directional affine merge candidate list;
   in response to the first flag indicating the bi-directional affine motion compensation being enabled for the first partition, and the second flag indicating the bi-directional affine motion compensation being not enabled for the second partition, decoding the first partition using the bi-directional affine merge candidate list and decoding the second partition using the uni-directional affine merge candidate list; and
   in response to the first flag and the second flag indicating the bi-directional affine motion compensation being enabled for both the first partition and the second partition, decoding both the first partition and the second partition using the bi-directional affine merge candidate list.
53. The method according to clause 49, further comprising:
   reordering candidates in the uni-directional affine merge candidate list and bi-directional affine merge candidate list by adaptive reordering of merge candidates with template matching (ARMC), respectively.
54. A method for signaling a bitstream, the method comprising:
receiving a video sequence;
encoding the video sequence by:
   dividing a coding unit (CU) into a first partition and a second partition;
   constructing at least one affine merge candidate list, wherein one of the at least one affine merge candidate list comprises bi-directional candidates; and
   encoding the CU using an affine geometric partition mode (GPM) using one of the at least one affine merge candidate list; and
signaling a bitstream that is generated based on the encoding.
55. The method according to clause 54, wherein constructing the at least one affine merge candidate list further comprises:
   constructing an initial affine merge candidate list for a regular merge mode; and
   encoding the CU using the affine GPM using the initial affine merge candidate list.
56. The method according to clause 54, wherein constructing the at least one affine merge candidate list further comprises:
   constructing an initial affine merge candidate list for a regular merge mode;
   extracting uni-directional candidates from the initial affine merge candidate list to obtain a uni-directional affine merge candidate list; and
   extracting bi-directional candidates from the initial affine merge candidate list to obtain a bi-directional affine merge candidate list; and
encoding the CU using the affine GPM using one of the at least one affine merge candidate list further comprising:
   encoding the CU using affine GPM using the uni-directional affine merge candidate list or the bi-directional merge candidate list.
57. The method according to clause 56, wherein encoding the CU using affine GPM using the uni-directional affine merge candidate list or the bi-directional merge candidate list further comprises:
   determining whether bi-directional motion vectors used for a plurality of neighbor positions of the CU;
   counting a number of the neighbor positions where the bi-directional motion vectors used;
   in response the number of the neighbor positions where the bi-directional motion vectors used being greater than or equal to a threshold, encoding the CU using the bi-directional merge candidate list.
58. The method according to clause 56, wherein encoding the CU using affine GPM using the uni-directional affine merge candidate list or the bi-directional merge candidate list further comprises:
   encoding a flag indicating which merge candidate list to be used;
   in response to the flag indicating the uni-directional merge candidate list to be used, encoding the CU using the uni-directional merge candidate list; and
   in response to the flag indicating the bi-directional merge candidate list to be used, encoding the CU using the bi-directional merge candidate list.
59. The method according to clause 56, wherein encoding the CU using affine GPM using the uni-directional affine merge candidate list or the bi-directional merge candidate list further comprises:
   encoding a first flag indicating whether bi-directional affine motion compensation is enabled for the first partition and a second flag indicating bi-directional affine motion compensation is enabled for the second partition;
   in response to the first flag and the second flag indicating the bi-directional affine motion compensation is enabled for none of the first partition and the second partition, encoding the both the first partition and the second partition using the uni-directional affine merge candidate list;
   in response to the first flag indicating the bi-directional affine motion compensation being not enabled for the first partition, and the second flag indicating the bi-directional affine motion compensation being enabled for the second partition, encoding the first partition using the uni-directional affine merge candidate list and encoding the second partition using the bi-directional affine merge candidate list;
   in response to the first flag indicating the bi-directional affine motion compensation being enabled for the first partition, and the second flag indicating the bi-directional affine motion compensation being not enabled for the second partition, encoding the first partition using the bi-directional affine merge candidate list and encoding the second partition using the uni-directional affine merge candidate list; and
   in response to the first flag and the second flag indicating the bi-directional affine motion compensation being enabled for both the first partition and the second partition, encoding both the first partition and the second partition using the bi-directional affine merge candidate list.
60. The method according to clause 56, further comprising:
   reordering candidates in the uni-directional affine merge candidate list and bi-directional affine merge candidate list by adaptive reordering of merge candidates with template matching (ARMC), respectively.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A method of encoding a video sequence, the method comprising:
receiving a video sequence;
encoding the video sequence by:
constructing a first merge candidate list of pairs of candidates from a regular geometric partition mode (GPM) candidate list for a code unit (CU);
constructing one or more additional merge candidate lists of pairs of candidates, wherein each pair of candidates comprises a first motion vector for a first partition and a second motion vector for a second partition, at least one of the pairs of candidates in the one or more additional merge candidate lists comprises an affine motion vector; and
encoding the CU using a regression GPM using the first merge candidate list or one of the one or more additional merge candidate lists, wherein the CU comprises a first partition and a second partition.

2. The method according to claim 1, wherein constructing the one or more additional merge candidate lists of pairs of candidates further comprises:
constructing a second merge candidate list of pairs of candidates from an affine GPM candidate list.

3. The method according to claim 2, wherein encoding the CU using the first merge candidate list or one of the one or more additional merge candidate lists further comprises:
encoding a flag indicating whether affine motion compensation (AMC) is enabled for the CU; and
in response to the flag indicating the AMC being enabled for the CU, encoding the CU using the second merge candidate list.

4. The method according to claim 2, wherein constructing the one or more additional merge candidate lists of pairs of candidates for regression GPM further comprises:
constructing a third merge candidate list of pairs of candidates, wherein a first motion vector in a pair of candidates is selected from regular GPM candidates, and a second motion vector in the pair of candidates is selected from affine GPM candidates; and
constructing a fourth merge candidate list of pairs of candidates, wherein a first motion vector in a pair of candidates is selected from affine GPM candidates, and a second motion vector in the pair of candidates is selected from regular GPM candidates.

5. The method according to claim 4, wherein encoding the CU using the first merge candidate list or one of the one or more additional merge candidate lists further comprises:
encoding a first flag indicating whether affine motion compensation (AMC) is enabled for the first partition and a second flag indicating the AMC is enabled for the second partition;
in response to the first flag and the second flag indicating the AMC is enabled for none of the first partition and the second partition, encoding the CU using the first merge candidate list;
in response to the first flag indicating the AMC being not enabled for the first partition, and the second flag indicating the AMC being enabled for the second partition, encoding the CU using the third merge candidate list;
in response to the first flag indicating the AMC being enabled for the first partition, and the second flag indicating the AMC being not enabled for the second partition, encoding the CU using the fourth merge candidate list; and
in response to the first flag and the second flag indicating the AMC being enabled for both the first partition and the second partition, encoding the CU using the second merge candidate list.

6. The method according to claim 4, wherein encoding the CU using the first merge candidate list or one of the one or more additional merge candidate lists further comprises:
encoding a first flag indicating whether affine motion compensation (AMC) is enabled for the CU;
in response to the first flag indicating the AMC is enabled for the CU, encoding a second flag indicating whether the AMC is enabled for the first partition;
in response to the second flag indicating the AMC being not enabled for the first partition, encoding the CU using the third merge candidate list;
in response to the second flag indicating the AMC being enabled for the first partition, encoding the CU using the fourth merge candidate list.

7. The method according to claim 4, further comprising:
merging the first merge candidate list, the second merge candidate list, the third merge candidate list, and the fourth merge candidate list into a fifth merge candidate list;
reordering pairs of candidates in the fifth merge candidate list with template cost values; and
encoding the CU using the fifth merge candidate list.

8. A method for decoding a bitstream, the method comprising:
receiving a bitstream; and
decoding the bitstream to generate a video sequence, the decoding comprising:
constructing a first merge candidate list of pairs of candidates from a regular geometric partition mode (GPM) candidate list for a code unit (CU);
constructing one or more additional merge candidate lists of pairs of candidates, wherein each pair of candidates comprises a first motion vector for a first partition and a second motion vector for a second partition, at least one of the pairs of candidates in the one or more additional merge candidate lists comprises an affine motion vector; and
decoding the CU using a regression GPM using the first merge candidate list or one of the one or more additional merge candidate lists, wherein the CU comprises a first partition and a second partition.

9. The method according to claim 8, wherein constructing the one or more additional merge candidate lists of pairs of candidates further comprises:
constructing a second merge candidate list of pairs of candidates from an affine GPM candidate list.

10. The method according to claim 9, wherein decoding the CU using the first merge candidate list or one of the one or more additional merge candidate lists further comprises:
decoding a flag indicating whether affine motion compensation (AMC) is enabled for the CU; and
in response to the flag indicating the AMC being enabled for the CU, decoding the CU using the second merge candidate list.

11. The method according to claim 9, wherein constructing the one or more additional merge candidate lists of pairs of candidates for regression GPM further comprises:
constructing a third merge candidate list of pairs of candidates, wherein a first motion vector in a pair of candidates is selected from regular GPM candidates, and a second motion vector in the pair of candidates is selected from affine GPM candidates; and
constructing a fourth merge candidate list of pairs of candidates, wherein a first motion vector in a pair of candidates is selected from affine GPM candidates, and a second motion vector in the pair of candidates is selected from regular GPM candidates.

12. The method according to claim 11, wherein decoding the CU using the first merge candidate list or one of the one or more additional merge candidate lists further comprises:
decoding a first flag indicating whether affine motion compensation (AMC) is enabled for the first partition and a second flag indicating the AMC is enabled for the second partition;
in response to the first flag and the second flag indicating the AMC is enabled for none of the first partition and the second partition, decoding the CU using the first merge candidate list;
in response to the first flag indicating the AMC being not enabled for the first partition, and the second flag indicating the AMC being enabled for the second partition, decoding the CU using the third merge candidate list;
in response to the first flag indicating the AMC being enabled for the first partition, and the second flag indicating the AMC being not enabled for the second partition, decoding the CU using the fourth merge candidate list; and
in response to the first flag and the second flag indicating the AMC being enabled for both the first partition and the second partition, decoding the CU using the second merge candidate list.

13. The method according to claim 11, wherein decoding the CU using the first merge candidate list or one of the one or more additional merge candidate lists further comprises:
decoding a first flag indicating whether affine motion compensation (AMC) is enabled for the CU;
in response to the first flag indicating the AMC is enabled for the CU, decoding a second flag indicating whether the AMC is enabled for the first partition;
in response to the second flag indicating the AMC being not enabled for the first partition, decoding the CU using the third merge candidate list;
in response to the second flag indicating the AMC being enabled for the first partition, decoding the CU using the fourth merge candidate list.

14. The method according to claim 11, further comprising:
merging the first merge candidate list, the second merge candidate list, the third merge candidate list, and the fourth merge candidate list into a fifth merge candidate list;
reordering pairs of candidates in the fifth merge candidate list with template cost values; and
decoding the CU using the fifth merge candidate list.

15. A method for signaling a bitstream, the method comprising:
receiving a video sequence;
encoding the video sequence by:
constructing a first merge candidate list of pairs of candidates from a regular geometric partition mode (GPM) candidate list for a code unit (CU);
constructing one or more additional merge candidate lists of pairs of candidates, wherein each pair of candidates comprises a first motion vector for a first partition and a second motion vector for a second partition, at least one of the pairs of candidates in the one or more additional merge candidate lists comprises an affine motion vector; and
encoding the CU using a regression GPM using the first merge candidate list or one of the one or more additional merge candidate lists, wherein the CU comprises a first partition and a second partition; and
signaling a bitstream that is generated based on the encoding.

16. The method according to claim 15, wherein constructing the one or more additional merge candidate lists of pairs of candidates further comprises:
constructing a second merge candidate list of pairs of candidates from an affine GPM candidate list.

17. The method according to claim 16, wherein encoding the CU using the first merge candidate list or one of the one or more additional merge candidate lists further comprises:
encoding a flag indicating whether affine motion compensation (AMC) is enabled for the CU; and
in response to the flag indicating the AMC being enabled for the CU, encoding the CU using the second merge candidate list.

18. The method according to claim 16, wherein constructing the one or more additional merge candidate lists of pairs of candidates for regression GPM further comprises:
constructing a third merge candidate list of pairs of candidates, wherein a first motion vector in a pair of candidates is selected from regular GPM candidates, and a second motion vector in the pair of candidates is selected from affine GPM candidates; and
constructing a fourth merge candidate list of pairs of candidates, wherein a first motion vector in a pair of candidates is selected from affine GPM candidates, and a second motion vector in the pair of candidates is selected from regular GPM candidates.

19. The method according to claim 18, wherein encoding the CU using the first merge candidate list or one of the one or more additional merge candidate lists further comprises:
encoding a first flag indicating whether affine motion compensation (AMC) is enabled for the first partition and a second flag indicating the AMC is enabled for the second partition;
in response to the first flag and the second flag indicating the AMC is enabled for none of the first partition and the second partition, encoding the CU using the first merge candidate list;
in response to the first flag indicating the AMC being not enabled for the first partition, and the second flag indicating the AMC being enabled for the second partition, encoding the CU using the third merge candidate list;
in response to the first flag indicating the AMC being enabled for the first partition, and the second flag indicating the AMC being not enabled for the second partition, encoding the CU using the fourth merge candidate list; and
in response to the first flag and the second flag indicating the AMC being enabled for both the first partition and the second partition, encoding the CU using the second merge candidate list.

20. The method according to claim 18, further comprising:
merging the first merge candidate list, the second merge candidate list, the third merge candidate list, and the fourth merge candidate list into a fifth merge candidate list;
reordering pairs of candidates in the fifth merge candidate list with template cost values; and
encoding the CU using the fifth merge candidate list.
